(19) United States
(12) Patent Application Publication
(10) Pub. No.: US 2012/0219321 A1
(43) Pub. Date: Aug. 30, 2012

(54) TONER, IMAGE FORMING APPARATUS, IMAGE FORMING METHOD AND PROCESS CARTRIDGE

(76) Inventors: Tomohiro Fukao, Osaka (JP); Takuya Kadota, Hyogo (JP); Yoshihiro Mikuriya, Hyogo (JP); Tsuyoshi Nozaki, Osaka (JP); Yoshimichi Ishikawa, Hyogo (JP); Atsushi Yamamoto, Shizuoka (JP); Tomoharu Miki, Osaka (JP); Kazuoki Fuwa, Hyogo (JP)

(21) Appl. No.: 13/504,771

(22) PCT Filed: Oct. 27, 2010
(86) PCT No.: PCT/JP2010/069544

§ 371 Date: Apr. 27, 2012

(30) Foreign Application Priority Data
Oct. 27, 2009 (JP) 2009-246034
Nov. 12, 2009 (JP) 2009-258688

(51) Int. Cl. G03G 21/18; G03G 9/16; G03G 9/087; G03G 15/08

(52) U.S. Cl. 399/111; 399/252; 430/109.1; 430/109.3

(57) ABSTRACT

A toner including a binder resin, a colorant and protruding portions on a surface of the toner, wherein the average length of long sides of the protruding portions is 0.1 μm or greater, but less than 0.5 μm, wherein the standard deviation of the lengths of the long sides of the protruding portions is 0.2 or less, and wherein the protruding portions have a coverage of 30% to 90%.

### TECHNICAL FIELD

The present invention relates to an electrostatic image developing dry toner used to develop a latent electrostatic image formed in an electrophotographic method, an electrostatic recording method or an electrostatic printing method, and also relates to an image forming apparatus, an image forming method and a process cartridge which use the toner.

### BACKGROUND ART

Dry-type developing devices each using a developer in powder form are widely employed in image forming apparatuses (such as electronic copiers, printers and facsimiles) in which an latent electrostatic image is formed on a latent image bearing member, then the latent electrostatic image is visualized with the developer and a recorded image is thus obtained.

In recent years, electrophotographic color image forming apparatuses have been becoming more and more popular. Also, further increase in the definition of printed images is being demanded, which is related to the fact that digitalized images are easily available. In attempts to improve the resolution and gradation of images more, further increase in sphericity and further reduction in particle diameter are examined with respect to toners with which latent images are visualized, for the purpose of forming high-definition images. Since such properties of toners produced by pulverization methods are limited, so-called polymerization toners (which can be further increased in sphericity and further reduced in particle diameter), produced by suspension polymerization methods, emulsion polymerization methods, dispersion polymerization methods or the like, tend to be employed at the moment.

However, polymerization toners present problems such as degradation of transfer efficiency and occurrence of filming (which are due to the fact that the polymerization toners are reduced in particle diameter, and thus their adhesion to members increases) as well as degradation of cleanability (which is due to the sphericity of the toners). Also, in the production of the polymerization toners, toner components with relatively low resistance are distributed in a biased manner to the vicinities of the surfaces of toner base particles, and thus there exists a problem of background smears caused by the low chargeability of the toners.

Further, since toners with improved low-temperature fixability, which are intended for energy saving, are in high demand, use of binder resins having low melting temperatures is preferable. However, when a toner with improved low-temperature fixability is designed, there exists a new problem, i.e., lack of heat-resistant storage stability. Specifically, when a toner or a cartridge containing a toner is transported, a certain pressure is applied to the toner in many cases; therefore, merely increasing the glass transition temperature of the surfaces of toner particles by surface modification cannot avoid pressure-related deformation of the toner in a high-temperature and high-humidity environment. Hence, attention should be paid also to the glass transition temperature of toner base particles. Note that a favorable balance between low-temperature fixability and heat-resistant storage stability under a certain pressure cannot be sufficiently secured in any of the prior art documents described below.

Attempts have been made to subject toner base particles to surface modification and thereby solve the above-mentioned problems. As a method of surface modification, PTL 1 discloses a method in which part or all of toner base particle surfaces formed of first resin particles and a colorant are covered with second resin particles. In this method, however, the second resin particles are sparse and nonuniform to a great extent, and thus prevention of background smears and improvement in storage stability cannot be sufficiently yielded, although there is improvement in cleanability. Moreover, degradation of transferability is caused.

PTL 2 is aimed at securing favorable frictional chargeability and cleanability and proposes a microcapsule toner which includes: a core material composed of a fixing component and a colorant; an outer shell that covers the surroundings of the core material; and hemispherical protruding structural units on the entire surface of the outer shell, wherein each hemispherical protruding structural unit measures 0.01 μm to 2 μm in diameter and 0.001 μm to 2 μm in height.

However, this proposal does not mention control of the uniformity of the hemispherical protruding structural units on the outer shell, and the method disclosed herein improves cleanability but cannot sufficiently yield prevention of background smears or improvement in storage stability.

PTL 3 proposes an electrostatic image developing spherical toner (having a circularity of 0.97 or greater) which includes a toner core, and a concavo-convex shape formed on a surface of the toner core, wherein the toner is produced by dissolving or dispersing, in a solvent, at least a colorant, a release agent, a binder resin and a charge controlling resin, and produced in accordance with an O/W wet granulation method, and wherein protruding portions in the concavo-convex shape are in a granular form and have an average particle diameter of 100 nm to 500 nm and a coverage of 10% to 80% with respect to the surface of the toner core.

In this proposal, however, the charge controlling resin contained in the protruding portions has high polarity and thus greatly varies in properties depending upon the environment, thereby presenting problems, for example concerning background smears in a high-temperature and high-humidity environment, and heat-resistant storage stability.

### CITATION LIST

### Patent Literature

PTL 1 Japanese Patent Application Laid-Open (JP-A) No. 2008-090256
PTL 2 Japanese Patent (JP-B) No. 2844795
PTL 3 JP-A No. 2008-233430

### SUMMARY OF INVENTION

### Technical Problem

The present invention is aimed at providing an electrostatic image developing dry toner with superior low-temperature fixability as well as with improved chargeability, adhesion resistance, cleanability and heat-resistant storage stability; and also providing an image forming apparatus, an image forming method and a process cartridge which use the toner.

### Solution to Problem

As a result of carrying out a series of earnest examinations to solve the problems, the present inventors have found that the problems can be solved by a toner including a binder resin, a colorant and protruding portions on a surface of the toner, wherein the average length of long sides of the protruding portions is 0.1 μm or greater, but less than 0.5 μm, wherein the standard deviation of the lengths of the long sides of the protruding portions is 0.2 or less, and wherein the protruding portions have a coverage of 30% to 90%.

The present invention is based upon the findings of the present inventors, and means for solving the problems are as follows.

<1> A toner including: a binder resin; a colorant; and protruding portions on a surface of the toner, wherein the average length of long sides of the protruding portions is 0.1 μm or greater, but less than 0.5 μm, wherein the standard deviation of the lengths of the long sides of the protruding portions is 0.2 or less, and wherein the protruding portions have a coverage of 30% to 90%.
<2> The toner according to <1>, wherein the toner has a glass transition temperature Tg1 which satisfies Relationship (1) below:

45° C.≦Tg1≦70° C. Relationship (1)

<3> The toner according to <1> or <2>, wherein the protruding portions contain a resin whose glass transition temperature Tg2 satisfies Relationship (2) below:

45° C.≦Tg2≦100° C. Relationship (2)

<4> The toner according to any one of <1> to <3>, wherein the glass transition temperature Tg1 of the toner and the glass transition temperature Tg2 of the resin contained in the protruding portions satisfy Relationships (3) to (5) below:

50° C.≦Tg1≦65° C. Relationship (3)

60° C.≦Tg2≦100° C. Relationship (4)

Tg1<Tg2 Relationship (5)

<5> The toner according to <3> or <4>, wherein the resin contained in the protruding portions is a styrene-containing resin.
<6> The toner according to any one of <3> to <5>, wherein the mass of the resin contained in the protruding portions occupies 1% to 20% of the total mass of the toner.
<7> The toner according to any one of <3> to <6>, wherein the resin contained in the protruding portions is a vinyl resin obtained by polymerizing a monomer mixture which contains 80% by mass to 100% by mass of an aromatic compound having a vinyl polymerizable functional group relative to the total mass of the monomer mixture.
<8> The toner according to any one of <3> to <7>, wherein the resin contained in the protruding portions is a vinyl resin obtained by polymerizing a monomer mixture which contains 100% by mass of the aromatic compound having the vinyl polymerizable functional group relative to the total mass of the monomer mixture.
<9> The toner according to <7>, wherein the monomer mixture for the resin contained in the protruding portions includes 80% by mass to 100% by mass of styrene and 0% by mass to 20% by mass of butyl acrylate, with the total amount of these two components being in the range of 90% by mass to 100% by mass relative to the total mass of the monomer mixture.
<10> The toner according to any one of <1> to <9>, wherein the toner has a volume average particle diameter of 3 μm to 9 μm.
<11> The toner according to any one of <1> to <10>, wherein the ratio of the volume average particle diameter of the toner to the number average particle diameter of the toner, represented by “volume average particle diameter/number average particle diameter”, is 1.25 or less.
<12> The toner according to any one of <1> to <11>, wherein the toner has an average circularity of 0.93 or greater.
<13> An image forming apparatus including: a latent image bearing member configured to bear a latent image thereon; a charging unit configured to uniformly charge a surface of the latent image bearing member; an exposing unit configured to expose the charged surface of the latent image bearing member, based upon image data, so as to write a latent electrostatic image on the surface of the latent image bearing member; a developing unit configured to supply a toner to the latent electrostatic image formed on the surface of the latent image bearing member so as to develop the latent electrostatic image and thereby form a visible image; a transfer unit configured to transfer the visible image on the surface of the latent image bearing member to a transfer target object; and a fixing unit configured to fix the visible image on the transfer target object, wherein the toner is the toner according to any one of <1> to <12>.
<14> An image forming method including: uniformly charging a surface of a latent image bearing member; exposing the charged surface of the latent image bearing member, based upon image data, so as to write a latent electrostatic image on the surface of the latent image bearing member; supplying a toner to the latent electrostatic image formed on the surface of the latent image bearing member so as to develop the latent electrostatic image and thereby form a visible image; transferring the visible image on the surface of the latent image bearing member to a transfer target object; and fixing the visible image on the transfer target object, wherein the toner is the toner according to any one of <1> to <12>.
<15> A process cartridge detachably mountable to an image forming apparatus, including: a latent image bearing member; and a developing unit configured to develop a latent electrostatic image on the latent image bearing member, using a toner, the latent image bearing member and the developing unit constituting a single unit, wherein the toner is the toner according to any one of <1> to <12>.

### Advantageous Effects of Invention

The present invention solves the problems in related art and achieves the aim of: providing an electrostatic image developing dry toner which has improved chargeability, adhesion resistance, cleanability and heat-resistant storage stability, with its low-temperature fixability maintained, and which thereby makes it possible to form high-quality images, by placing protruding portions of uniform size on the surfaces of toner base particles; and providing an image forming apparatus, an image forming method and a process cartridge which use the toner.

### BRIEF DESCRIPTION OF DRAWINGS

FIG. 1 is a drawing for explaining a method of measuring a protruding portion of a toner in the present invention.

FIG. 2 is an SEM photograph showing the exterior of a particle of the toner obtained in Example 1 of the present invention.

FIG. 3 is an SEM photograph showing the exterior of a particle of the toner obtained in Comparative Example 6.

FIG. 4 is a schematic drawing showing the structure of a process cartridge according to an embodiment of the present invention.

FIG. 5 is a schematic cross-sectional view showing the structure of an image forming apparatus according to an embodiment of the present invention.

FIG. 6 is a schematic cross-sectional view showing the structure of an image forming portion where a photoconductor is placed.

FIG. 7 is a schematic cross-sectional view showing the structure of a developing device.

FIG. 8 is a schematic cross-sectional view showing the structure of a process cartridge.

FIG. 9 is an SEM photograph showing the exterior of a toner particle in Example 14.

### DESCRIPTION OF EMBODIMENTS

### Toner

A toner of the present invention is a toner including a binder resin and a colorant, to which an external additive (for helping enhance fluidity, developability and chargeability of the toner) is preferably added. If necessary, the toner may further include a release agent, a charge controlling agent, a plasticizer, etc.

In the present invention, the toner has, on its surface, protruding portions wherein the average length of long sides of the protruding portions is 0.1 μm or greater, but less than 0.5 μm, wherein the standard deviation of the lengths of the long sides of the protruding portions is 0.2 or less, and wherein the protruding portions have a coverage of 30% to 90%.

The average length of the long sides of the protruding portions is 0.1 μm or greater but less than 0.5 μm, preferably in the range of 0.1 μm to 0.3 μm. When the average length of the long sides of the protruding portions is 0.5 μm or greater, the protruding portions on the surface are sparse and thus favorable effects of the surface modification may not be obtained.

The standard deviation of the lengths of the long sides of the protruding portions is 0.2 or less, preferably 0.1 or less. When the standard deviation is greater than 0.2, there may be trouble which stems from the unevenness of the surface.

The protruding portions have a coverage of 30% to 90%, preferably 40% to 80%, more preferably 50% to 70%. When the protruding portions have a coverage of less than 30%, background smears may appear and the heat-resistant storage stability of the toner may be insufficient. When the protruding portions have a coverage of more than 90%, the low-temperature fixability of the toner may degrade.

### —Long Sides of Protruding Portions and Coverage of Protruding Portions—

The toner is observed using a scanning electron microscope (SEM), and the lengths of the long sides of the protruding portions and the coverage of the protruding portions with respect to the toner surface are calculated based upon an SEM image obtained.

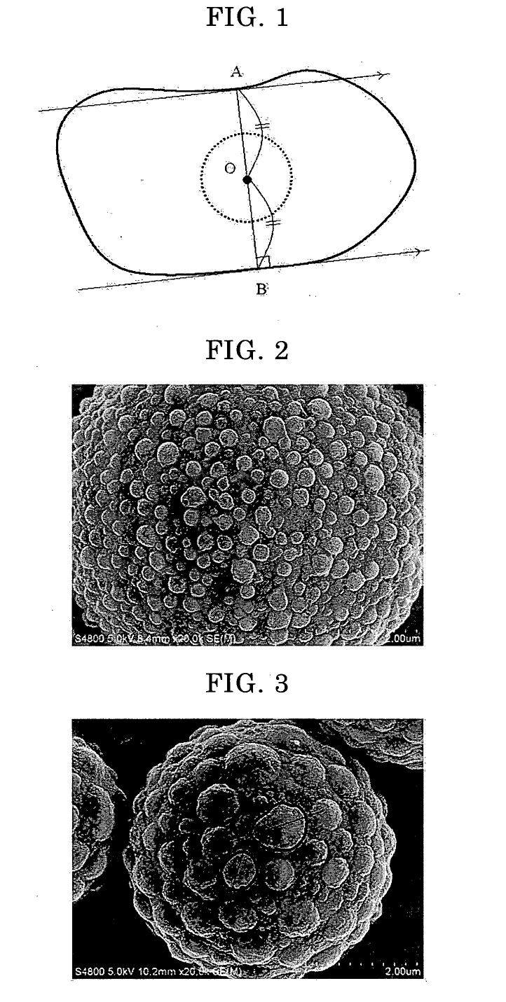

Referring to FIG. 1, the following explains a method of calculating the lengths of the long sides of the protruding portions and the coverage of the protruding portions, mentioned in Examples below.

### —Coverage—

(1) The shortest distance between two parallel lines touching a toner particle is measured, with the points of tangency being denoted by A and B respectively.
(2) Based upon the area of a circle whose diameter is equivalent to the length of the line segment AO (O denotes the central point of the line segment AB) and upon the area of protruding portions present in the circle, the coverage of the protruding portions with respect to the toner surface is calculated.
(3) The coverage of the protruding portions, regarding 100 or more toner particles, is calculated as described above then the average value is calculated.

### —Average Length of Long Sides—

(1) The average length of the long sides of the protruding portions is determined by measuring the lengths of the long sides of 100 or more protruding portions with respect to 100 or more toner particles, then calculating the average value.

In Examples below, 100 toner particles were selected, the length of the long side of one protruding portion per toner particle was measured, and this measurement was carried out on those 100 toner particles selected.

(2) The Image Analysis Type Particle Size Distribution Measuring Software “MAC-VIEW” (manufactured by Mountech Co., Ltd.) is used to measure the area of the protruding portions and the lengths of the long sides of the protruding portions.

### <Sea-Island Structure>

The toner of the present invention is preferably composed of: a main portion (otherwise referred to as “sea portion”, “colored particles” or “toner base (particles)”) which contains at least a binder resin and a colorant and which may also contain a release agent; and protruding portions (otherwise referred to as “convex portions” or “island portions”) made of resin fine particles, which are formed on the surface of the main portion. The binder resin contained in the sea portion includes at least a non-crystalline resin and preferably includes a crystalline resin as well. The resin fine particles include at least a non-crystalline resin. The crystalline resin and the non-crystalline resin are incompatible with each other and present in a sea-island state in the toner.

The binder resin contained in the sea portion is not particularly limited and may be suitably selected according to the intended purpose. Nevertheless, use of a resin having a polyester backbone is preferable because favorable toner fixability can be obtained. Examples of the resin having a polyester backbone include polyester resins, and block polymers which are each composed of a polyester resin and a resin having a backbone other than a polyester backbone. Preference is given to polyester resins because the obtained toner has high uniformity.

In the present invention, by providing a toner in which protruding portions that contain a resin constituting a dispersion are formed on the surfaces of colored particles, it is possible to improve the cleanability and heat-resistant storage stability of the toner, with the low-temperature fixability of the toner being maintained; also, by making the protruding portions have a uniform size, the toner can have uniform and stable chargeability and adhesion resistance, which makes it possible to achieve formation of high-quality images.

### <Binder Resin>

Examples of the binder resin include polyesters, polyurethanes, polyureas, epoxy resins and vinyl resins. Examples thereof also include hybrid resins each containing chemically bonded resins of different kinds. Examples thereof further include resins in which reactive functional groups are introduced into their terminals or side chains and the reactive functional groups are bonded in a production process of the toner so as to elongate the resins. Any one of these resins may be solely used. Nevertheless, to produce a toner having protruding portions of uniform size, the resin contained in toner particles is preferably different from the resin contained in the protruding portions.

The binder resin contained in the colored particles is a resin, at least part of which is soluble in an organic solvent. The acid value of the resin is preferably in the range of 2 mgKOH/g to 24 mgKOH/g. When the acid value is greater than 24 mgKOH/g, transfer of the resin to an aqueous phase easily arises; consequently, problems easily arise in which there is loss of supply and consumption of materials in a production process or the dispersion stability of oil droplets degrades. Moreover, the toner increases in moisture adsorption, and thus not only does the chargeability of the toner decrease but also the storage stability of the toner degrades in a high-temperature and high-humidity environment. When the acid value is less than 2 mgKOH/g, it is difficult to uniformly disperse the colorant (which has polarity to some extent) in oil droplets because the polarity of the binder resin decreases.

The type of the binder resin is not particularly limited and may be suitably selected according to the intended purpose. In the case where the binder resin is used for a latent electrostatic image developing toner in electrophotography, use of a resin having a polyester backbone is preferable because favorable toner fixability can be obtained. Examples of the resin having a polyester backbone include polyester resins, and block polymers which are each composed of a polyester resin and a resin having a backbone other than a polyester backbone. Preference is given to polyester resins because the obtained colored resin particles have high uniformity.

Examples of the polyester resins include ring-opened polymerization products of lactones, polycondensation products of hydroxycarboxylic acids, and polycondensation products which are each composed of a polyol and a polycarboxylic acid. In terms of design-related freedom, preference is given to polycondensation products which are each composed of a polyol (hereinafter referred to also as “polyol (1)”) and a polycarboxylic acid (hereinafter referred to also as “polycarboxylic acid (2)”).

The peak molecular weight of any of these polyester resins is preferably in the range of 1,000 to 30,000, more preferably 1,500 to 10,000, even more preferably 2,000 to 8,000. When the peak molecular weight is less than 1,000, the heat-resistant storage stability of the toner may degrade. When the peak molecular weight is greater than 30,000, the low-temperature fixability of the toner may degrade for a latent electrostatic image developing toner.

The glass transition temperature of any of the polyester resins is preferably in the range of 45° C. to 70° C., more preferably 50° C. to 65° C. In the case where core particles are covered with protruding portions as in the present invention, the resin contained in the protruding portions could be plasticized by moisture in the air when the toner is stored in a high-temperature and high-humidity environment, thereby possibly causing a decrease in glass transition temperature. While the toner or a toner cartridge is transported, such a high-temperature and high-humidity environment as 40° C. and 90% RH (relative humidity) is probable; if the colored resin particles are under a certain pressure, they may deform, or they may adhere to one another, and thus they may not be able to behave in the intended manner as particles; therefore, the glass transition temperature should not be lower than 45° C. When the glass transition temperature is higher than 70° C., it is not preferred because in the case where the colored resin particles are used for a latent electrostatic image developing toner, the low-temperature fixability of the toner degrades.

### <Polyol>

Examples of the polyol (1) include diols (1-1) and trihydric or higher polyols (1-2). It is preferable to use (1-1) alone, or a mixture of (1-1) and a small amount of (1-2).

Examples of the diols (1-1) include alkylene glycols (ethylene glycol, 1,2-propylene glycol, 1,3-propylene glycol, 1,4-butanediol, 1,6-hexanediol, etc.); alkylene ether glycols (diethylene glycol, triethylene glycol, dipropylene glycol, polyethylene glycol, polypropylene glycol, polytetramethylene ether glycol, etc.); alicyclic diols (1,4-cyclohexanedimethanol, hydrogenated bisphenol A, etc.); bisphenols (bisphenol A, bisphenol F, bisphenol S, etc.); alkylene oxide (ethylene oxide, propylene oxide, butylene oxide, etc.) adducts of the alicyclic diols; 4,4′-dihydroxybiphenyls such as 3,3′-difluoro-4,4′-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also called “tetrafluorobisphenol A”) and 2,2-bis(3-hydroxyphenyl)-1,1,1,3,3,3-hexafluoropropane; bis(4-hydroxyphenyl)ethers such as bis(3-fluoro-4-hydroxyphenyl)ether; and alkylene oxide (ethylene oxide, propylene oxide, butylene oxide, etc.) adducts of the bisphenols.

Preferable among these are C2-C12 alkylene glycols and alkylene oxide adducts of bisphenols, particularly alkylene oxide adducts of bisphenols, and combinations of these and C2-C12 alkylene glycols.

Examples of the trihydric or higher polyols (1-2) include trihydric to octahydric or higher aliphatic alcohols (glycerin, trimethylolethane, trimethylolpropane, pentaerythritol, sorbitol, etc.); trihydric or higher phenols (trisphenol PA, phenol novolac, cresol novolac, etc.); and alkylene oxide adducts of the trihydric or higher phenols.

### <Polycarboxylic Acid>

Examples of the polycarboxylic acid (2) include dicarboxylic acids (2-1) and trivalent or higher polycarboxylic acids (2-2). It is preferable to use (2-1) alone, or a mixture of (2-1) and a small amount of (2-2).

Examples of the dicarboxylic acids (2-1) include alkylene dicarboxylic acids (succinic acid, adipic acid, sebacic acid, etc.), alkenylene dicarboxylic acids (maleic acid, fumaric acid, etc.), aromatic dicarboxylic acids (phthalic acid, isophthalic acid, terephthalic acid, naphthalenedicarboxylic acid, etc.), 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid and hexafluoroisopropylidene diphthalic anhydride. Preferable among these are C4-C20 alkenylene dicarboxylic acids and C8-C20 aromatic dicarboxylic acids.

Examples of the trivalent or higher polycarboxylic acids (2-2) include C9-C20 aromatic polycarboxylic acids (trimellitic acid, pyromellitic acid, etc.). Additionally, the polycarboxylic acid (2) may be selected from acid anhydrides or lower alkyl esters (methyl ester, ethyl ester, isopropyl ester, etc.) of the above compounds and reacted with the polyol (1).

As for the ratio of the polyol to the polycarboxylic acid, the equivalence ratio [OH]/[COOH] of the hydroxyl group [OH] to the carboxyl group [COOH] is preferably in the range of 2/1 to 1/2, more preferably 1.5/1 to 1/1.5, even more preferably 1.3/1 to 1/1.3.

### <Modified Resin>

For the purpose of, for example, increasing the mechanical strength of the obtained colored resin particles or (in the case where the obtained colored resin particles are used for a latent electrostatic image developing toner) preventing hot offset at the time of toner fixation as well as increasing the mechanical strength, the colored resin particles may be obtained by dissolving in an oil phase an isocyanate group-terminated modified resin. Examples of methods of obtaining the modified resin include a method of obtaining an isocyanate group-containing resin by a polymerization reaction with an isocyanate group-containing monomer, and a method of obtaining an active hydrogen-terminated resin by polymerization and then reacting this resin with a polyisocyanate so as to introduce isocyanate groups into polymer terminals. Preference is given to the latter method in view of the controllability yielded by the introduction of the isocyanate groups into the polymer terminals. Examples of the active hydrogen include hydroxyl groups (alcoholic hydroxyl group and phenolic hydroxyl group), amino groups, carboxyl group and mercapto group, with preference being given to alcoholic hydroxyl group.

In view of uniformity of particles, the backbone of the modified resin is preferably the same as the backbone of the resin, at least part of which is soluble in an organic solvent. Preference is given to a polyester backbone. To obtain a resin including an alcoholic hydroxyl group-terminated polyester, it is advisable to perform a polycondensation reaction between a polyol and a polycarboxylic acid, with the number of functional groups of the polyol being larger than that of functional groups of the polycarboxylic acid.

### <Amine Compound>

The isocyanate groups of the modified resin undergo hydrolysis in a process of dispersing an oil phase in an aqueous phase (aqueous medium) and thusly obtaining particles, and some of the isocyanate groups change to amino groups. Then the produced amino groups react with unreacted isocyanate groups, and thus an elongation reaction proceeds. Additionally, an amine compound (hereinafter referred to also as “amine compound (B)”) may also be used for the purpose of surely effecting the elongation reaction or introducing a cross-linking point. Examples of the amine compound (B) include diamines (B1), trivalent or higher amines (B2), amino alcohols (B3), amino mercaptans (B4), amino acids (B5), and compounds (B6) which are each obtained by blocking amino groups of any of (B1) to (B5).

Examples of the diamines (B1) include aromatic diamines (phenylenediamine, diethyltoluenediamine, 4,4′-diaminodiphenylmethane, tetrafluoro-p-xylylenediamine, tetrafluoro-p-phenylenediamine, etc.); alicyclic diamines (4,4′-diamino-3,3′-dimethyldicyclohexylmethane, diaminecyclohexane, isophoronediamine, etc.); and aliphatic diamines (ethylenediamine, tetramethylenediamine, hexamethylenediamine, dodecafluorohexylenediamine, tetracosafluorododecylenediamine, etc.). Examples of the trivalent or higher amines (B2) include diethylenetriamine and triethylenetetramine.

Examples of the amino alcohols (B3) include ethanolamine and hydroxyethylaniline. Examples of the amino mercaptans (B4) include aminoethyl mercaptan and aminopropyl mercaptan. Examples of the amino acids (B5) include aminopropionic acid and aminocaproic acid.

Examples of the compounds (B6), which are each obtained by blocking amino groups of any of (B1) to (B5), include oxazoline compounds and ketimine compounds derived from the amines of (B1) to (B5) and ketones (acetone, methy ethyl ketone, methyl isobutyl ketone, etc.). Among these amine compounds, use of (B1) alone or a mixture of (B1) and a small amount of (B2) is preferable.

As for the ratio of the amine compound (B), the number of amino groups [NHx] in the amine compound (B) is 4 or fewer times as many, preferably 2 or fewer times as many, more preferably 1.5 or fewer times as many, even more preferably 1.2 or fewer times as many, as the number of isocyanate groups [NCO] in an isocyanate group-containing prepolymer. When the number of amino groups [NHx] is more than 4 times as many, surplus amino groups block the isocyanate groups, and the elongation reaction of the modified resin is hindered from taking place properly. Consequently, the molecular weight of the polyester is low, and the hot offset resistance of the toner degrades.

### —Crystalline Polyester Resin—

The toner of the present invention may include a crystalline polyester to improve its low-temperature fixability.

The crystalline polyester, too, can be obtained as a polycondensation product of a polyol and a polycarboxylic acid, as described above. The polyol is preferably an aliphatic diol. Examples of the aliphatic diol include ethylene glycol, 1,2-propylene glycol, 1,3-propylene glycol, 1,4-butanediol, 1,5-pentanediol, 1,6-hexanediol, 1,7-heptanediol, 1,8-octanediol, neopentyl glycol and 1,4-butenediol. Preferable among these are 1,4-butanediol, 1,6-hexanediol and 1,8-octanediol, particularly 1,6-hexanediol. The polycarboxylic acid is preferably an aromatic dicarboxylic acid (such as phthalic acid, isophthalic acid or terephthalic acid) or a C2-C8 aliphatic carboxylic acid. Use of the aliphatic carboxylic acid is particularly preferred in view of an increase in crystallinity.

Note that the crystalline resin (crystalline polyester) and the non-crystalline resin are distinguished from each other based upon thermal properties. The crystalline resin is, for example, a resin (such as a wax) having a clear endothermic peak in a DSC measurement. Meanwhile, in the case of the non-crystalline resin, a gentle curve based upon glass transition is observed.

### <Organic Solvent>

It is preferred that the organic solvent be volatile, having a boiling point lower than 100° C., because subsequent solvent removal can be facilitated.

Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used individually or in combination.

In the case where the resin dissolved or dispersed in the organic solvent is a resin having a polyester backbone, it is preferable to use an ester solvent such as methyl acetate, ethyl acetate or butyl acetate, or a ketone solvent such as methyl ethyl ketone or methyl isobutyl ketone because these solvents have high dissolving capability. Particularly preferable among these are methyl acetate, ethyl acetate are methyl ethyl ketone in view of solvent removability.

### <Aqueous Medium>

The aqueous medium may consist only of water or may consist of water and a solvent miscible with water. Examples of the solvent miscible with water include alcohols (methanol, isopropanol, ethylene glycol, etc.), dimethylformamide, tetrahydrofuran, cellosolves (methyl cellosolve, etc.) and lower ketones (acetone, methyl ethyl ketone, etc.).

### <Surfactant>

A surfactant may be used to produce droplets by dispersing an oil phase in the aqueous medium.

Examples of the surfactant include anionic surfactants such as alkylbenzene sulfonates, α-olefin sulfonates and phosphoric acid esters; amine salt-based cationic surfactants such as alkylamine salts, aminoalcohol fatty acid derivatives, polyamine fatty acid derivatives and imidazoline; quaternary ammonium salt-based cationic surfactants such as alkyltrimethylammonium salts, dialkyldimethylammonium salts, alkyldimethylbenzylammonium salts, pyridinium salts, alkylisoquinolinium salts and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaines. Also, use of a fluoroalkyl group-containing surfactant makes it possible to produce its effects even when used in very small amounts.

Suitable examples of fluoroalkyl group-containing anionic surfactants include C2-C10 fluoroalkyl carboxylic acids or metal salts thereof, disodium perfluorooctanesulfonylglutamate, sodium 3-[ω-fluoroalkyl(C6-C11)oxy]-1-alkyl(C3-C4)sulfonate, sodium 3-[ω-fluoroalkanoyl(C6-C8)-N-ethylamino]-1-propanesulfonate, fluoroalkyl(C11-C20)carboxylic acids or metal salts thereof, perfluoroalkylcarboxylic acids(C7-C13) or metal salts thereof, perfluoroalkyl(C4-C12)sulfonic acids or metal salts thereof, perfluorooctanesulfonic acid diethanolamide, N-propyl-N-(2-hydroxyethyl)perfluorooctanesulfonamide, perfluoroalkyl(C6-C10)sulfonamide propyltrimethylammonium salts, perfluoroalkyl(C6-C10)-N-ethylsulfonylglycine salts and monoperfluoroalkyl(C6-C16)ethyl phosphoric acid esters. Examples of cationic surfactants include fluoroalkyl group-containing aliphatic primary, secondary or tertiary amine acids, aliphatic quaternary ammonium salts (such as perfluoroalkyl(C6-C10)sulfonamide propyltrimethylammonium salts), benzalkonium salts, benzetonium chloride, pyridinium salts and imidazolinium salts.

### <Inorganic Dispersant>

Dissolved matter or dispersed matter of a toner composition may be dispersed in the aqueous medium in the presence of an inorganic dispersant or resin fine particles. Examples of the inorganic dispersant include tricalcium phosphate, calcium carbonate, titanium oxide, colloidal silica and hydroxyappetite. Use of the dispersant is preferable in that a sharp particle size distribution and stable dispersion can be realized.

### <Protective Colloid>

Also, a polymeric protective colloid may be added to stabilize dispersion droplets.

Examples thereof include acids such as acrylic acid, methacrylic acid, α-cyanoacrylic acid, α-cyanomethacrylic acid, itaconic acid, crotonic acid, fumaric acid, maleic acid and maleic anhydride; hydroxyl group-containing (meth)acrylic monomers such as acrylic acid β-hydroxyethyl, methacrylic acid β-hydroxyethyl, acrylic acid β-hydroxypropyl, methacrylic acid β-hydroxypropyl, acrylic acid γ-hydroxypropyl, methacrylic acid γ-hydroxypropyl, acrylic acid-3-chloro-2-hydroxypropyl, methacrylic acid-3-chloro-2-hydroxypropyl, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide; vinyl alcohol and ethers of vinyl alcohol such as vinyl methyl ether, vinyl ethyl ether and vinyl propyl ether; esters of carboxyl group-containing compounds and vinyl alcohol, such as vinyl acetate, vinyl propionate and vinyl butyrate; acrylamide, methacrylamide, diacetone acrylamide, and methylol compounds thereof; acid chlorides such as acrylic acid chloride and methacrylic acid chloride; homopolymers or copolymers of nitrogen-containing compounds such as vinyl pyridine, vinyl pyrolidone, vinyl imidazole and ethyleneimine, and of such nitrogen-containing compounds having heterocyclic rings; polyoxyethylene-based compounds such as polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester and polyoxyethylene nonyl phenyl ester; and celluloses such as methyl cellulose, hydroxyethyl cellulose and hydroxypropyl cellulose.

In the case where a substance soluble in acid and/or alkali, such as a calcium phosphate salt, is used as a dispersion stabilizer, the substance is dissolved in an acid, e.g. hydrochloric acid, and then removed from fine particles, for example by washing with water. Besides, its removal is enabled by a process such as decomposition brought about by an enzyme. In the case where the dispersant is used, the dispersant may remain on the surfaces of toner particles; nevertheless, in terms of toner chargeability, it is preferable to wash off the dispersant after an elongation and/or cross-linking reaction.

### <Colorant>

The colorant is not particularly limited and may be suitably selected from known dyes and pigments. Examples thereof include carbon black, nigrosine dyes, iron black, Naphthol Yellow S, Hansa Yellow (10G, 5G, G), cadmium yellow, yellow iron oxide, yellow ocher, yellow lead, titanium yellow, polyazo yellow, oil yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, Anthrazane Yellow BGL, isoindolinone yellow, red ocher, red lead, lead vermilion, cadmium red, cadmium mercury red, antimony vermilion, Permanent Red 4R, Para Red, Fire Red, p-chlor-o-nitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red FSR, Brilliant Carmine 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarine Lake, Thioindigo Red B, Thioindigo Maroon, oil red, quinacridone red, pyrazolone red, polyazo red, chrome vermilion, benzidine orange, perynone orange, oil orange, cobalt blue, cerulean blue, Alkali Blue Lake, Peacock Blue Lake, Victoria Blue Lake, metal-free phthalocyanine blue, phthalocyanine blue, Fast Sky Blue, Indanthrene Blue (RS, BC), indigo, ultramarine, Prussian blue, anthraquinone blue, Fast Violet B, Methyl Violet Lake, cobalt violet, manganese violet, dioxane violet, anthraquinone violet, chrome green, zinc green, chromium oxide, viridian, emerald green, Pigment Green B, Naphthol Green B, Green Gold, Acid Green Lake, Malachite Green Lake, phthalocyanine green, anthraquinone green, titanium oxide, zinc oxide, lithopone, and mixtures thereof.

As for the amount of the colorant, the colorant preferably occupies 1% by mass to 15% by mass, more preferably 3% by mass to 10% by mass, of the toner.

### <Colorant for Use in Masterbatch>

The colorant may be compounded with a resin to form a masterbatch.

Examples of binder resins used for producing masterbatches or kneaded with masterbatches include (besides the above-mentioned modified or unmodified polyester resins) polymers of styrenes such as polystyrene, poly-p-chlorostyrene and polyvinyltoluene, and of substitution products of the styrenes; styrene copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer and styrene-maleic acid ester copolymer; polymethyl methacrylate, polybutyl methacrylate, polyvinyl chloride, polyvinyl acetate, polyethylene, polypropylene, polyesters, epoxy resins, epoxy polyol resins, polyurethanes, polyamides, polyvinyl butyral, polyacrylic acid resins, rosins, modified rosins, terpene resins, aliphatic or alicyclic hydrocarbon resins, aromatic petroleum resins, chlorinated paraffins and paraffin waxes. These may be used individually or in combination.

### <Production Method of Masterbatch>

The masterbatch can be obtained by mixing and kneading the colorant and the resin for use in a masterbatch, with the application of high shearing force. In doing so, an organic solvent may be used to enhance interaction between the colorant and the resin. Also, the so-called flushing method (in which an aqueous paste containing a colorant and water is mixed and kneaded with a resin and an organic solvent and then the colorant is transferred to the resin to remove the water and the organic solvent) is favorably used as well, since a wet cake of the colorant can be used without the need to change it in any way, and drying is therefore not needed. For the mixing and kneading, a high shearing dispersing apparatus such as a triple roll mill is favorably used.

### —External Additive—

The external additive may be suitably selected from known inorganic fine particles and polymeric fine particles. The external additive preferably has a primary particle diameter of 5 nm to 2 more preferably 5 nm to 500 nm. Also, the external additive preferably has a BET specific surface area of 20 m²/g to 500 m²/g. As for the proportion of the external additive used, the external additive preferably occupies 0.01% by mass to 5% by mass, more preferably 0.01% by mass to 2.0% by mass, of the toner.

Examples of the inorganic fine particles include fine particles of silica, alumina, titanium oxide, barium titanate, magnesium titanate, calcium titanate, strontium titanate, zinc oxide, tin oxide, silica sand, clay, mica, wollastonite, diatom earth, chromium oxide, cerium oxide, red ochre, antimony trioxide, magnesium oxide, zirconium oxide, barium sulfate, barium carbonate, calcium carbonate, silicon carbide and silicon nitride.

Examples of the polymeric fine particles include polymer particles of thermosetting resins, and polycondensation products such as nylon (registered trademark), benzoguanamine, silicone, acrylic acid ester copolymers, methacrylic acid esters and polystyrene, obtained by dispersion polymerization, suspension polymerization or soap-free emulsion polymerization.

Such a fluidizer subjects the toner particles to surface treatment and increases their hydrophobicity, thereby making it possible to prevent the fluidity and chargeability of the toner particles from degrading even at high humidity. Suitable examples thereof as surface-treating agents include silane coupling agents, silylating agents, fluorinated alkyl group-containing silane coupling agents, organic titanate-based coupling agents, aluminum-based coupling agents, silicone oils and modified silicone oils.

### —Release Agent—

For the purpose of enhancing its fixability and releasability, the toner may also include a release agent dispersed in the organic solvent.

As the release agent, a material (such as a wax or a silicone oil) which has sufficiently low viscosity when heated in a fixing process and which does not easily swell or become compatible with other colored resin particle materials on the surface of a fixing member. In view of the storage stability of the colored resin particles themselves, it is preferable to use a wax which is present as a solid in the toner when stored under normal conditions.

Examples of the wax include long-chain hydrocarbons and carbonyl group-containing waxes. Examples of the long-chain hydrocarbons include polyolefin waxes (such as polyethylene wax and polypropylene wax); petroleum waxes (such as paraffin wax, Sasol Wax and microcrystalline wax); and Fischer-Tropsch wax.

Examples of the carbonyl group-containing waxes include polyalkanoic acid esters (such as carnauba wax, montan wax, trimethylolpropane tribehenate, pentaerythritol tetrabehenate, pentaerythritol diacetate dibehenate, glycerin tribehenate and 1,18-octadecanediol distearate); polyalkanol esters (such as tristearyl trimellitate and distearyl maleate); polyalkanoic acid amides (such as ethylenediamine dibehenyl amide); polyalkylamides (such as tristearylamide trimellitate); and dialkyl ketones (such as distearyl ketone).

Among these, long-chain hydrocarbons, which are superior in releasability, are preferable. Further, in the case where a long-chain hydrocarbon is used as the release agent, a carbonyl group-containing wax may be additionally used. The release agent preferably occupies 2% by mass to 25% by mass, preferably 3% by mass to 20% by mass, even more preferably 4% by mass to 15% by mass, of the toner. When the release agent occupies less than 2% by mass, the fixability and releasability of the toner cannot be effectively improved. When the release agent occupies more than 25% by mass, the mechanical strength of the toner may decrease.

### —Charge Controlling Agent—

If necessary, the toner may include a charge controlling agent dissolved or dispersed in the organic solvent.

The charge controlling agent is not particularly limited and may be suitably selected from known charge controlling agents. Examples thereof include negrosine dyes, triphenylmethane dyes, chromium-containing metal complex dyes, molybdic acid chelate pigments, rhodamine dyes, alkoxy amines, quaternary ammonium salts (including fluorine-modified quaternary ammonium salts), alkyl amides, phosphorus, phosphorus compounds, tungsten, tungsten compounds, fluorine-based activating agents, salicylic acid metal salts, and metal salts of salicylic acid derivatives. Specific examples thereof include BONTRON 03 as a negrosine dye, BONTRON P-51 as a quaternary ammonium salt, BONTRON S-34 as a metal-containing azo dye, E-82 as an oxynaphthoic acid metal complex, E-84 as a salicylic acid metal complex, and E-89 as a phenolic condensate (manufactured by Orient Chemical Industries); TP-302 and TP-415 as quaternary ammonium salt molybdenum complexes (manufactured by Hodogaya Chemical Industries); COPY CHARGE PSY VP2038 as a quaternary ammonium salt, COPY BLUE PR as a triphenylmethane derivative, and COPY CHARGE NEG VP2036 and COPY CHARGE NX VP434 as quaternary ammonium salts (manufactured by Hoechst AG); LRA-901, and LR-147 as a boron complex (manufactured by Japan Carlit Co., Ltd.); copper phthalocyanine, perylene, quinacridone, azo pigments; and polymeric compounds having functional groups such as sulfonic acid group, carboxyl group, quaternary ammonium salt, etc.

The amount of the charge controlling agent will be satisfactory as long as the amount enables it to exhibit its performance and does not impair the fixability, etc. of the toner. The charge controlling agent preferably occupies 0.5% by mass to 5% by mass, more preferably 0.8% by mass to 3% by mass, of the toner.

### <Method for Producing Toner>

The method for producing the above-mentioned toner is not particularly limited and may be suitably selected according to the intended purpose. Examples of the method include known wet granulation methods such as a dissolution suspension method, a suspension polymerization method and an emulsion aggregation method; and known pulverization methods. Among these, a dissolution suspension method and an emulsion aggregation method (emulsion polymerization method) are preferable in that the diameter and shape of toner particles can be easily controlled.

In the case where colored particles (which serve as cores) are obtained by an emulsion method or a suspension polymerization method, colored particles (which serve as cores) are obtained by a known method, then resin fine particles are added into the system in a subsequent step such that the resin fine particles are attached or fusion-bonded to the surfaces of the colored particles (which serve as cores). To promote the attachment or the fusion bonding, heating may be carried out. Also, addition of a metal salt is effective in promoting the attachment or the fusion bonding.

### <Resin Fine Particles>

As the resin fine particles in the present invention, those dispersed in an aqueous medium can be used. Examples of the resin for the resin fine particles include vinyl resins, polyesters, polyurethanes, polyureas and epoxy resins. Among these, vinyl resins are preferable because resin fine particles dispersed in an aqueous medium can be obtained with ease. Examples of methods of obtaining an aqueous dispersion of vinyl resin fine particles include known polymerization methods such as an emulsion aggregation method, a suspension polymerization method and a dispersion polymerization method. Among these, an emulsion aggregation method is particularly preferable in that particles having diameters suitable for the present invention can be easily obtained.

### —Vinyl Resin Fine Particles—

The vinyl resin fine particles includes a vinyl resin obtained by polymerizing a monomer mixture which contains at least a styrene monomer.

To use the colored fine particles in the present invention as particles which function by being charged, for example for a latent electrostatic image developing toner, the surfaces of the colored fine particles preferably have a structure which makes it easy for the surfaces to be charged. In order to provide such a structure, the styrene monomer, having an electron orbit which allows electrons to be stably present as in an aromatic ring structure, occupies 50% by mass to 100% by mass, preferably 80% by mass to 100% by mass, more preferably 95% by mass to 100% by mass, of the monomer mixture. When the styrene monomer occupies less than 50% by mass, the chargeability of the obtained colored resin particles is poor, and the application of the colored resin particles is limited.

Here, the styrene monomer refers to an aromatic compound having a vinyl polymerizable functional group. Examples of the polymerizable functional group include vinyl group, isopropenyl group, allyl group, acryloyl group and methacryloyl group.

Examples of the styrene monomer include styrene, α-methylstyrene, 4-methylstyrene, 4-ethylstyrene, 4-tert-butylstyrene, 4-methoxystyrene, 4-ethoxystyrene, 4-carboxystyrene or metal salts thereof, 4-styrenesulfonic acid or metal salts thereof, 1-vinylnaphthalene, 2-vinylnaphthalene, allylbenzene, phenoxyalkylene glycol acrylate, phenoxyalkylene glycol methacrylate, phenoxypolyalkylene glycol acrylate and phenoxypolyalkylene glycol methacrylate. Among these, styrene monomers which are easily available, superior in reactivity and high in chargeability are preferable.

Also, in the vinyl resin for use in the present invention, an acid monomer occupies 0% by mass to 7% by mass, preferably 0% by mass to 4% by mass, of the monomer mixture. It is more preferred that no acid monomer be used. When an acid monomer occupies more than 7% by mass, the obtained vinyl resin fine particles themselves have high dispersion stability; therefore, even when such vinyl resin fine particles are added into a dispersion liquid in which oil droplets are dispersed in an aqueous phase, the particles are hardly attachable or are attachable but easily detach at normal temperature, and thus the particles easily separate in processes such as solvent removal, washing, drying and external addition treatment. Further, when an acid monomer occupies 4% or less, variation in chargeability can be reduced depending upon the environment where the obtained colored resin particles are used.

Here, the acid monomer refers to a compound having a vinyl polymerizable functional group and an acid group. Examples of the acid group include carboxyl group, sulfonyl group and phosphonyl group.

Examples of the acid monomer include carboxyl group-containing vinyl monomers or salts thereof (such as (meth)acrylic acid, maleic acid, maleic anhydride, monoalkyl maleates, fumaric acid, monoalkyl fumarates; crotonic acid, itaconic acid, monoalkyl itaconates, itaconic acid glycol monoether, citraconic acid, monoalkyl citraconates and cinnamic acid), sulfonic acid group-containing vinyl monomers, vinyl sulfuric acid monoesters or salts thereof, and phosphoric acid group-containing vinyl monomers or salts thereof. Among these, (meth)acrylic acid, maleic acid, maleic anhydride, monoalkyl maleates, fumaric acid and monoalkyl fumarates are particularly preferable.

To control the compatibility with the colored particles, a monomer having an ethylene oxide (EO) chain (such as phenoxyalkylene glycol acrylate, phenoxyalkylene glycol methacrylate, phenoxypolyalkylene glycol acrylate or phenoxypolyalkylene glycol methacrylate) is preferably used in such a manner as to occupy 10% by mass or less, more preferably 5% by mass or less, even more preferably 2% by mass or less, of the total amount of the monomers. When this monomer occupies more than 10%, it is not favorable because the environmental stability of charging noticeably decreases owing to an increase in the number of polar groups on the toner surface. Moreover, it is not favorable because the compatibility with the colored particles is too high and thus the burial rate of the protruding portions easily decreases. Additionally, to control the compatibility with the colored particles, a monomer having an ester bond, such as 2-acryloyloxyethyl succinate or 2-methacryloyloxyethylphthalic acid, may be simultaneously used. If used, this monomer occupies 10% by mass or less, preferably 5% by mass or less, more preferably 2% by mass or less, of the total amount of the monomers. When this monomer occupies more than 10% by mass, it is not favorable because the environmental stability of charging noticeably decreases owing to an increase in the number of polar groups on the toner surface. Moreover, it is not favorable because the compatibility with the colored particles is too high and thus the burial rate of the protruding portions easily decreases.

The method of obtaining the vinyl resin fine particles is not particularly limited and may be suitably selected according to the intended purpose. Examples thereof include the methods of (a) to (f) below.

(a) A monomer mixture is reacted by a polymerization reaction such as suspension polymerization, emulsion polymerization, seed polymerization or dispersion polymerization, and a dispersion liquid of vinyl resin fine particles is thus produced.
(b) A monomer mixture is polymerized beforehand, the obtained resin is pulverized using a fine pulverizer of mechanical rotation type, jet type, etc., then the pulverized resin is classified, and resin fine particles are thus produced.
(c) A monomer mixture is polymerized beforehand, the obtained resin is dissolved in a solvent so as to obtain a resin solution, the resin solution is sprayed in the form of mist, and resin fine particles are thus produced.
(d) A monomer mixture is polymerized beforehand, and a solvent is added to a resin solution obtained by dissolving the obtained resin in a solvent, or a resin solution obtained by previously dissolving a resin in a solvent with heating is cooled so as to precipitate resin fine particles, then the solvent is removed. In this manner, resin fine particles are produced.
(e) A monomer mixture is polymerized beforehand, the obtained resin is dissolved in a solvent so as to obtain a resin solution, the resin solution is dispersed in an aqueous medium in the presence of a certain dispersant, then the solvent is removed by heating, pressure reduction, etc.
(f) A monomer mixture is polymerized beforehand, the obtained resin is dissolved in a solvent so as to obtain a resin solution, a certain emulsifier is dissolved in the resin solution, then water is added so as to effect phase-inversion emulsification.

Among these, the method of (a) is preferable because the production of the vinyl resin fine particles is facilitated and they can be obtained in the form of a dispersion liquid, which enables their application to a subsequent step to be smooth.

In the method of (a) above, when the polymerization reaction is performed, employment of the following is preferable: a dispersion stabilizer is added into an aqueous medium; or such a monomer (so-called reactive emulsifier) as can impart dispersion stability to the resin fine particles produced by the polymerization is added into a monomer to be subjected to the polymerization reaction; or these two means are combined so as to impart dispersion stability to the produced vinyl resin fine particles. If neither a dispersion stabilizer nor a reactive emulsifier is used, it is not favorable for the following reasons: the dispersed state of the particles cannot be maintained, so that the vinyl resin may not be able to be obtained in the form of fine particles; the dispersion stability of the obtained resin fine particles is low, so that their storage stability is poor and thus they may aggregate when stored; or the dispersion stability of the particles decreases in the undermentioned resin fine particle attaching step, so that aggregation or unification among core particles easily arises and the uniformity of the particle diameter, shape, surface, etc. of the colored resin particles obtained as a final product degrades.

Examples of the dispersion stabilizer include surfactants and inorganic dispersants. Examples of the surfactants include anionic surfactants such as alkylbenzene sulfonates, α-olefin sulfonates and phosphoric acid esters; amine salt-based cationic surfactants such as alkylamine salts, aminoalcohol fatty acid derivatives, polyamine fatty acid derivatives and imidazoline; quaternary ammonium salt-based cationic surfactants such as alkyltrimethylammonium salts, dialkyldimethylammonium salts, alkyldimethylbenzylammonium salts, pyridinium salts, alkylisoquinolinium salts and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaines. Examples of the inorganic dispersants include tricalcium phosphate, calcium carbonate, titanium oxide, colloidal silica and hydroxyapatite.

The weight average molecular weight of the vinyl resin is preferably in the range of 3,000 to 300,000, more preferably 4,000 to 100,000, even more preferably 5,000 to 50,000. When the weight average molecular weight is less than 3,000, it is not favorable because of the following reasons: the vinyl resin has low mechanical strength and thus is brittle, so that the surfaces of toner particles vary easily depending upon the application of the toner obtained as a final product and upon use conditions; for example, a noticeable change in chargeability, smearing such as attachment of the toner particles to surrounding members, and a resultant quality-related problem are caused. When the weight-average molecular weight is greater than 300,000, it is not favorable because the number of molecular terminals of the vinyl resin decreases, so that there is less bonding of molecular chains between the vinyl resin and the core particles and thus the attachment capability of the vinyl resin to the core particles decreases.

Also, the glass transition temperature (Tg) of the vinyl resin is preferably in the range of 45° C. to 100° C., more preferably 55° C. to 90° C., even more preferably 65° C. to 80° C. The resin contained in the protruding portions could be plasticized by moisture in the air when the toner is stored in a high-temperature and high-humidity environment, thereby possibly causing a decrease in glass transition temperature. While the toner or a toner cartridge is transported, such a high-temperature and high-humidity environment as 40° C. and 90% RH is probable; if the obtained toner particles are under a certain pressure, they may deform, or they may adhere to one another, and thus they may not be able to behave in the intended manner as particles; therefore, the glass transition temperature should not be lower than 45° C. Also, when the toner is used for one-component development, the glass transition temperature should not be lower than 45° C., because the resistance of the toner to friction may decrease. When the glass transition temperature is higher than 100, it is not favorable because the fixability of the toner degrades.

### —Oil Phase Producing Step—

To produce an oil phase in which a resin, a colorant, etc. are dissolved or dispersed in an organic solvent, it is preferred that the resin, the colorant, etc. be gradually added into the organic solvent and thusly dissolved or dispersed therein. Note that when a pigment is used as the colorant or when a material (among a release agent, a charge controlling agent, etc.) which does not easily dissolve in the organic solvent is added, its particles are preferably reduced in size prior to its addition to the organic solvent.

The above-mentioned use of the colorant as a component of the masterbatch is a favorable means, and a similar means may be applied also to the release agent and the charge controlling agent.

As another means, there is a method of dispersing the colorant, the release agent and the charge controlling agent in a wet manner into the organic solvent, with a dispersion auxiliary agent added if necessary, to thereby obtain a wet master.

As yet another means, in the case where materials which melt at temperatures lower than the boiling point of the organic solvent are dispersed in the organic solvent, there is a method of carrying out heating while stirring the dispersoids in the organic solvent, with a dispersion auxiliary agent added if necessary, so as to dissolve the dispersoids, then carrying out cooling while performing stirring or shearing so as to effect crystallization, thereby producing fine crystals of the dispersoids.

Regarding the colorant, the release agent and the charge controlling agent dispersed using any of the above means, they may be redispersed after dissolved or dispersed together with the resin in the organic solvent. For their dispersion, a known dispersing apparatus, such as a bead mill or disc mill, may be used.

### —Toner Producing Step—

To disperse the oil phase (obtained by the above-mentioned step) in the aqueous medium including at least a surfactant and thereby produce a dispersion liquid in which colored particles formed of the oil phase are dispersed, a known apparatus may be used; examples of the apparatus include, but are not limited to, apparatuses employing low-speed shearing, high-speed shearing, friction, high-pressure jets or ultrasonic waves. To adjust the particle diameter of the dispersion to the range of 2 μm to 20 μm, use of an apparatus employing high-speed shearing is preferable. When an apparatus employing high-speed shearing is used, the rotational sped thereof is not particularly limited but is generally in the range of 1,000 rpm to 30,000 rpm, preferably 5,000 rpm to 20,000 rpm. The length of time of the dispersion is not particularly limited; in the case of batch dispersion, it is generally in the range of 0.1 minutes to 5 minutes. When the dispersion is carried out for over 5 minutes, it is not favorable because undesirable small-diameter particles may remain or the dispersion may be overdispersion, so that the system becomes unstable and aggregates or coarse particles may be generated. The temperature during the dispersion is generally in the range of 0° C. to 40° C., preferably 10° C. to 30° C. When the temperature is higher than 40° C., it is not favorable because the molecular motion becomes active, which causes a decrease in dispersion stability and easily generates aggregates or coarse particles. When the temperature is lower than 0° C., the viscosity of the dispersion increases, and the quantity of shear energy required for the dispersion increases, so that there may be a decrease in production efficiency.

As the surfactant, a surfactant which is the same as any of the ones mentioned in relation to the production method of the resin fine particles may be used. To efficiently disperse the oil droplets containing the solvent, use of a disulfonic acid salt with a high HLB value is preferable.

The concentration of the surfactant in the aqueous medium is preferably in the range of 1% by mass to 10% by mass, more preferably 2% by mass to 8% by mass, even more preferably 3% by mass to 7% by mass. When the concentration of the surfactant is more than 10% by mass, it is not favorable because the oil droplets may become too small in size or the oil droplets may become coarse owing to a decrease in dispersion stability caused by formation of an inverted micelle structure. When the concentration of the surfactant is less than 1%, it is not favorable because the oil droplets cannot be stably dispersed and thus the oil droplets may become coarse.

### —Method of Forming Protruding Portions—

The protruding portions in the present invention are raised parts provided on the toner base surface, and ends of the protruding portions tend to have shapes similar to spheres because of surface tension. The manner in which the protruding portions are fusion-bonded is not particularly limited; for example, the protruding portions may each have a spherical shape, part of which is buried, or may each have a hemispherical shape fusion-bonded to the surface.

Examples of methods of forming the protruding portions include a method in which resin fine particles including at least a resin are attached or fusion-bonded to colored particles (which serve as cores) including at least a binder resin and a colorant. To efficiently perform the attachment or the fusion-bonding between the colored particles (which serve as cores) and the resin fine particles, it is preferable to disperse these particles in the aqueous medium, with the dispersion stabilizer added in a controlled manner.

Here, what determine the shape and uniformity of the protruding portions are the proportion of the surfactant present in the aqueous medium, the composition of the resin fine particles, and the timing of the fusion bonding.

In the case where a dissolution suspension method is used, the attachment or the fusion bonding may be performed in accordance with the above-mentioned method. Nevertheless, it is preferable to add the resin fine particles and attach or fusion-bond them to the surfaces of oil phase droplets, in a state where an oil phase prepared by dissolving or dispersing the constituent materials of the colored particles (which serve as cores) in the organic solvent is dispersed in the aqueous medium, because the resin fine particles can be firmly attached or fusion-bonded to the colored particles. Addition of the resin fine particles during the production of the toner core particles is not favorable because the resulting protruding portions may become coarse and nonuniform.

In the obtained colored particle dispersion liquid, droplets of the core particles can be kept present in a stable manner while stirring is carried out. In this state, the resin fine particle dispersion liquid is poured so as to be attached onto the colored particles. It is advisable to pour the vinyl resin fine particle dispersion liquid, spending 30 seconds or more. When it is poured in less than 30 seconds, it is not favorable because aggregated particles may be generated owing to a dramatic change in the dispersion system, or the vinyl resin fine particles may not be uniformly attached. When the vinyl resin fine particle dispersion liquid is poured in a long period of time, for example over 60 minutes, it is not favorable in terms of production efficiency.

For concentration adjustment, the vinyl resin fine particle dispersion liquid may be diluted or concentrated before poured into the core particle dispersion liquid. The concentration of the vinyl resin fine particles in the dispersion liquid is preferably in the range of 5% by mass to 30% by mass, more preferably 8% by mass to 20% by mass. When the concentration of the vinyl resin fine particles is less than 5% by mass, it is not favorable because the organic solvent concentration greatly varies owing to the pouring of the dispersion liquid and thus the resin fine particles are not sufficiently attached. When the concentration of the vinyl resin fine particles is greater than 30% by mass, it is not favorable because the resin fine particles are liable to be unevenly distributed in the core particle dispersion liquid and thus the resin fine particles are not uniformly attached.

In the case where the oil phase droplets are produced, the surfactant occupies 7% by mass or less, preferably 6% by mass or less, more preferably 5% by mass or less, of the overall aqueous phase. When the surfactant occupies more than 7% by mass of the overall aqueous phase, it is not favorable because the uniformity of the length of the long sides of the protruding portions decreases noticeably.

The reasons why the methods in the present invention make it possible for the vinyl resin fine particles to be attached to the core particles with sufficient strength are perhaps as follows: when the vinyl resin fine particles are attached to the droplets of the core particles, the core particles can deform freely, so that the core particles have adequate surfaces which are in contact with the vinyl resin fine particles; and the organic solvent causes the vinyl resin fine particles to swell or dissolve therein, so that it becomes easier for the vinyl resin fine particles to stick to the resin included in the core particles. Therefore, regarding the foregoing state, the organic solvent needs to be adequately present in the system. Specifically, in the core particle dispersion liquid, the amount of the organic solvent is in the range of 50% by mass to 150% by mass, preferably 70% by mass to 125% by mass, relative to 100 parts by mass of the solid content (the resin and the colorant, if necessary with the addition of the release agent, the charge controlling agent, etc.). When the amount of the organic solvent is more than 150 parts by mass, it is not favorable because the amount of the colored resin particles obtained in one production step is small, the production efficiency is low, and the large amount of the organic solvent reduces dispersion stability and thus makes stable production difficult.

The temperature at which the vinyl resin fine particles are attached to the core particles is preferably in the range of 10° C. to 60° C., more preferably 20° C. to 45° C. When the temperature is higher than 60° C., it is not favorable because the production-related environmental load increases owing to an increase in the quantity of energy required for the production, and the presence of the vinyl resin fine particles (which are low in acid value) on the surfaces of the droplets makes the dispersion unstable, which possibly leads to generation of coarse particles. When the temperature is lower than 10° C., it is not favorable because the viscosity of the dispersion increases and the resin fine particles are not sufficiently attached.

The resin contained in the resin fine particles preferably occupies 1% by mass to 20% by mass, more preferably 3% by mass to 15% by mass, even more preferably 5% by mass to 10% by mass, of the overall toner. When the resin contained in the resin fine particles occupies less than 1% by mass, the obtained effects may be insufficient. When the resin contained in the resin fine particles occupies more than 20% by mass, surplus resin fine particles may be weakly attached to the toner core particles, which causes filming and the like.

Besides, there is a method of mixing and stirring the toner base particles and the resin fine particles such that the resin fine particles are attached to and cover the toner base particles in a mechanical manner.

### <Solvent Removing Step>

To remove the organic solvent from the obtained colored resin dispersion, it is possible to employ a method of gradually increasing the temperature while stirring the entire system, and completely removing the organic solvent in the droplets by evaporation.

Alternatively, it is possible to employ a method of spraying the obtained colored resin dispersion into a dry atmosphere with stirring, and thus completely removing the organic solvent in the droplets, or a method of reducing the pressure while stirring the colored resin dispersion, and removing the organic solvent by evaporation. The latter two methods can be used in combination with the former method.

As the dry atmosphere into which the emulsified dispersion is sprayed, what is generally used is a gas obtained by heating air, nitrogen, carbon dioxide, combustion gas or the like, particularly a gas flow heated to a temperature higher than or equal to the boiling point of the highest-boiling-point solvent used. Treatment with a spray dryer, belt dryer, rotary kiln or the like in a short period of time makes it possible to achieve the intended quality.

### <Aging Step>

In the case where the isocyanate group-terminated modified resin is added, an aging step may be carried out to promote an elongation and/or cross-linking reaction of the isocyanate group. The length of time of the aging is generally in the range of 10 minutes to 40 hours, preferably 2 hours to 24 hours. The reaction temperature is generally in the range of 0° C. to 65° C., preferably 35° C. to 50° C.

### <Washing Step>

The dispersion liquid of the colored resin particles obtained as described above contains sub-material(s) such as the surfactant, the dispersant, etc. besides the colored resin particles. Accordingly, washing is carried out to remove only the colored resin particles from these components. Examples of methods of washing the colored resin particles include, but are not limited to, a centrifugation method, a reduced-pressure filtration method and a filter press method. A cake of the colored resin particles can be obtained by any of these methods. If the washing cannot be sufficiently performed in one operation, a step of redispersing the obtained cake in an aqueous solvent so as to produce a slurry and then removing the colored resin particles from the slurry by any of the above methods may be repeated. Also, in the case where the washing is performed by a reduced-pressure filtration method or a filter press method, the sub-material(s) held by the colored resin particles may be washed away by passing an aqueous solvent through the cake. The aqueous solvent used for the washing is water or a mixed solvent obtained by mixing water with an alcohol such as methanol or ethanol, with preference being given to the use of water in view of cost and an environmental load imposed by discharge treatment or the like.

### <Drying Step>

The aqueous solvent is held to a great extent by the colored resin particles obtained through the washing. Accordingly, drying is carried out to remove the aqueous solvent, and thus only the colored resin particles can be obtained. For the drying, a dryer may be used such as a spray dryer, vacuum freeze dryer, reduced-pressure dryer, stationary shelf-type dryer, movable shelf-type dryer, fluid-bed dryer, rotary dryer or agitation dryer. The colored resin particles are preferably dried until their water content becomes less than 1% by mass in the end. Also, the colored resin particles which have been dried will be in a softly flocculated state; if this causes trouble in practical use, the colored resin particles may be pulverized using an apparatus such as a jet mill, Henschel mixer, Super mixer, coffee mill, Oster blender or food processor so as to remove the softly flocculated state.

### —Particle Diameter of Toner—

To uniformly and sufficiently charge the toner of the present invention, the volume average particle diameter of the toner is preferably in the range of 3 μm to 9 μm, more preferably 4 μm to 8 μm, even more preferably 4 μm to 7 μm. When the volume average particle diameter is less than 3 μm, it is not favorable because the attachment force of the toner relatively increases and thus the operability of the toner by means of an electric field degrades. When the volume average particle diameter is greater than 9 μm, image quality such as reproducibility of thin lines may decrease.

Also, the ratio of the volume average particle diameter of the toner to the number average particle diameter of the toner, represented by “volume average particle diameter/number average particle diameter”, is preferably 1.25 or less, more preferably 1.20 or less, even more preferably 1.17 or less. When the ratio (volume average particle diameter/number average particle diameter) is greater than 1.25, the uniformity of the particle diameter of the toner is poor and thus the size of the protruding portions easily varies. Also, in the course of repeated use, large-diameter toner particles or, in some cases, small-diameter toner particles are consumed more than other toner particles are, and the average particle diameter of the toner remaining in a developing device varies, so that the optimum conditions for developing the remaining toner deviate. Consequently, phenomena such as charging failure, extreme increase or decrease in the amount of the toner conveyed, clogging with the toner and spillage of the toner easily arise.

As a measuring apparatus for measuring the particle size distribution of the toner, COULTER COUNTER TA-II, COULTER MULTISIZER II (both manufactured by Coulter Corporation), etc. may be used, for example. The following describes a method of measuring the particle size distribution.

Firstly, 0.1 mL to 5 mL of a surfactant (preferably alkylbenzene sulfonate) is added as a dispersant into 100 mL to 150 mL of an electrolytic aqueous solution. Here, the electrolytic aqueous solution is an approximately 1% NaCl aqueous solution prepared using primary sodium chloride; for example, ISOTON-II (manufactured by Coulter Corporation) may be used as the electrolytic aqueous solution. Subsequently, 2 mg to 20 mg of a measurement sample is added. The electrolytic aqueous solution in which the sample is suspended is subjected to dispersion treatment for 1 minute to 3 minutes using an ultrasonic dispersion apparatus. Then, by means of the measuring apparatus, with an aperture of 100 μm employed, the volume and the number of toner (toner particles) are measured, and the volume distribution and the number distribution are calculated. The volume average particle diameter and the number average particle diameter of the toner can be calculated from the obtained distributions.

As channels, the following 13 channels are used: a channel of 2.00 μm or greater, but less than 2.52 μm; a channel of 2.52 μm or greater, but less than 3.17 μm; a channel of 3.17 μm or greater, but less than 4.00 μm; a channel of 4.00 μm or greater, but less than 5.04 μm; a channel of 5.04 μm or greater, but less than 6.35 μm; a channel of 6.35 μm or greater, but less than 8.00 μm; a channel of 8.00 μm or greater, but less than 10.08 μm; a channel of 10.08 μm or greater, but less than 12.70 μm; a channel of 12.70 μm or greater, but less than 16.00 μm; a channel of 16.00 μm or greater, but less than 20.20 μm; a channel of 20.20 μm or greater, but less than 25.40 μm; a channel of 25.40 μm or greater, but less than 32.00 μm; and a channel of 32.00 μm or greater, but less than 40.30 μm. Particles having diameters which are equal to or greater than 2.00 μm, but less than 40.30 μm are targeted.

### —Shape of Toner—

The toner preferably has an average circularity of 0.93 or greater, more preferably 0.95 or greater, even more preferably 0.97 or greater. When the toner has an average circularity of less than 0.93, the fluidity of the toner is low, so that development-related trouble easily arises and there is a decrease in transfer efficiency.

The average circularity of the toner is, for example, measured using the flow-type particle image analyzer FPIA-2000. The following is a specific measuring method: 0.1 mL to 0.5 mL of a surfactant, preferably alkylbenzene sulfonate, is added as a dispersant into 100 mL to 150 mL of water (placed in a container) from which solid impurities have previously been removed; then approximately 0.1 g to approximately 0.5 g of a measurement sample is added. The suspension in which the sample is dispersed is subjected to dispersion treatment for 1 minute to 3 minutes using an ultrasonic dispersion apparatus, the shape and the distribution of the toner (toner particles) are measured by means of the analyzer, adjusting the concentration of the dispersion liquid such that the number of toner particles is in the range of 3,000 per microliter to 10,000 per microliter, and the average circularity is thus obtained.

In the case where the toner is produced by a wet granulation method, ionic constituent materials for the toner are distributed in a biased manner to the vicinity of the surface, and thus the resistance of the surface layer of the toner is relatively low. Consequently, the charging rate of the toner increases and toner particles' rising capability upon charging improves, but there is a problem in which the charge sustainability of the toner is poor or the charge amount of the toner is liable to decrease rapidly. To rectify this problem, there is, for example, a method in which a surface modifying material is borne on the toner surface.

### —Measurement of Particle Diameter of Vinyl Resin Fine Particles—

The particle diameter of the vinyl resin fine particles can be measured using UPA-150EX (manufactured by NIKKISO CO., LTD.), for example.

The particle diameter of the resin fine particles is preferably in the range of 50 nm to 200 nm, more preferably 80 nm to 160 nm, even more preferably 100 nm to 140 nm. When the particle diameter is less than 50 nm, it is not favorable because it is difficult to form protruding portions of large enough size on the toner surface. When the particle diameter is greater than 200 nm, it is not favorable because the protruding portions are liable to be nonuniform.

### (Process Cartridge)

The toner of the present invention can be suitably used in a process cartridge of the present invention.

A process cartridge of the present invention includes a latent image bearing member, and a developing unit configured to develop a latent electrostatic image formed on the latent image bearing member, using the toner, and thereby form a visible image.

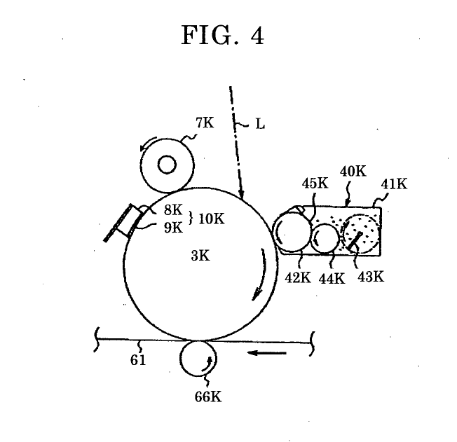

The toner of the present invention can be used in an image forming apparatus provided with a process cartridge shown, for example, in FIG. 4.

The process cartridge shown in FIG. 4 includes a latent electrostatic image bearing member 3K, a charging unit 7K, a charging member 10K configured to recharge toner remaining on the surface of the latent electrostatic image bearing member after the transfer of image(s) from the latent electrostatic image bearing member to a member in a subsequent step, and a developing unit 40K. This process cartridge is constructed in such a manner as to be detachably mountable to the main body of an image forming apparatus such as a copier or printer.

Here, operation of the process cartridge is explained. The latent electrostatic image bearing member 3K is rotationally driven at a predetermined circumferential velocity. While the latent electrostatic image bearing member 3K is rotated, the circumferential surface thereof is positively or negatively charged by the charging unit 7K in a uniform manner at a predetermined potential; subsequently, upon receipt of image exposure light L emitted from an image exposing unit such as a unit employing slit exposure, laser beam scanning exposure, etc., latent electrostatic images are sequentially formed on the surface of the latent electrostatic image bearing member 3K, then the formed latent electrostatic images are developed with a toner by the developing unit 40K, and the developed images (toner images) are sequentially transferred by a transfer unit 66K to a transfer target material 61 fed from a paper feed unit (not shown) to the part between the latent electrostatic image bearing member 3K and the transfer unit 66K in synchronization with the rotation of the latent electrostatic image bearing member 3K.

The transfer target material 61 to which the images have been transferred is then separated from the surface of the latent electrostatic image bearing member and introduced to an image fixing unit to fix the images thereto, and subsequently the transfer target material 61 with the fixed images is printed out as a copy or a print to the outside of the apparatus.

On the surface of the latent electrostatic image bearing member 3K after the image transfer, residual toner which has not been transferred is recharged by the charging member 10K that includes an elastic portion 8K and a conductive sheet 9K (formed of a conductive material) and that is configured to recharge toner remaining on the surface of the latent electrostatic image bearing member after the transfer of image(s) from the latent electrostatic image bearing member to a member in a subsequent step. Then the toner is passed through a charged portion of the latent electrostatic image bearing member, collected in a developing step and repeatedly used for image formation.

The developing unit 40K includes a casing 41K, and a developing roller 42K, the circumferential surface of which is partially exposed from an opening provided in the casing 41K.

Regarding the developing roller 42K serving as a developer bearing member, shafts protruding from both ends thereof with respect to the lengthwise direction are supported in a rotatable manner by respective bearings (not shown).

The casing 41K houses a K toner, and the K toner is conveyed by a rotationally driven agitator 43K from the right side to the left side in the drawing.

At the left side (in the drawing) of the agitator 43K, there is provided a toner supplying roller 44K which is rotationally driven in a counterclockwise direction (in the drawing) by a driving unit (not shown). The roller portion of this toner supplying roller 44K is made of an elastic foamed material such as a sponge and thus favorably receives the K toner sent from the agitator 43K.

The K toner received as just described is then supplied to the developing roller 42K through the contact portion between the toner supplying roller 44K and the developing roller 42K.

The K toner borne on the surface of the developing roller 42K serving as a developer bearing member is regulated in terms of its layer thickness and effectively subjected to frictional charging when passing through the position where it comes into contact with a regulatory blade 45K, as the developing roller 42K is rotationally driven in the counterclockwise direction (in the drawing). Thereafter, the K toner is conveyed to a developing region that faces the latent electrostatic image bearing member (photoconductor) 3K.

### <Charging Member>

In view of adhesion of the toner, the charging member configured to recharge the toner remaining on the surface of the latent electrostatic image bearing member after the transfer of image(s) from the latent electrostatic image bearing member to a member in a subsequent step is preferably conductive because, if the charging member is insulative, the toner will adhere to it due to an increase in charge.

The charging member is preferably a sheet made of a material selected from nylon, PTFE, PVDF and urethane. Particularly preferable among these are PTFE and PVDF in terms of chargeability of the toner.

The charging member preferably has a surface resistance of 10² Ω/sq. to 10⁸ Ω/sq. and a volume resistance of 10¹ Ω/sq. to 10⁶ Ω/sq.

The charging member is preferably in the form of a roller, a brush, a sheet, etc. In view of releasability of the attached toner, the charging member is particularly preferably in the form of a sheet.

In view of charging of the toner, the voltage applied to the charging member is preferably in the range of −1.4 kV to 0 kV.

In the case where the charging member is in the form of a conductive sheet, it is preferred (in view of the contact pressure between the charging member and the latent electrostatic image bearing member) that the thickness of the charging member be in the range of 0.05 mm to 0.5 mm.

Also, in view of the length of time of contact between the charging member and the latent electrostatic image bearing member when the toner is charged, it is preferred that the nip width (where the charging member is in contact with the latent electrostatic image bearing member) be in the range of 1 mm to 10 mm.

### (Image Forming Apparatus and Image Forming Method)

An image forming apparatus of the present invention includes: a latent image bearing member configured to bear a latent image; a charging unit configured to uniformly charge a surface of the latent image bearing member; an exposing unit configured to expose the charged surface of the latent image bearing member, based upon image data, so as to write a latent electrostatic image on the surface of the latent image bearing member; a developing unit configured to supply a toner to the latent electrostatic image formed on the surface of the latent image bearing member so as to develop the latent electrostatic image and thereby form a visible image; a transfer unit configured to transfer the visible image on the surface of the latent image bearing member to a transfer target object; and a fixing unit configured to fix the visible image on the transfer target object. If necessary, the image forming apparatus may further include suitably selected other unit(s) such as a charge eliminating unit, a cleaning unit, a recycling unit, a controlling unit, etc.

An image forming method of the present invention includes the steps of: uniformly charging a surface of a latent image bearing member; exposing the charged surface of the latent image bearing member, based upon image data, so as to write a latent electrostatic image on the surface of the latent image bearing member; forming a developer layer of a predetermined thickness over a developer bearing member by means of a developer layer regulating member, and developing the latent electrostatic image formed on the surface of the latent image bearing member with the use of the developer layer, thereby forming a visible image; transferring the visible image on the surface of the latent image bearing member to a transfer target object; and fixing the visible image on the transfer target object. Note that the image forming method may not include all of these steps. If necessary, the image forming method may further include suitably selected other step(s) such as a charge eliminating step, a cleaning step, a recycling step, a controlling step, etc.

The latent electrostatic image can be formed, for example, by uniformly charging the surface of the latent image bearing member by means of the charging unit and then exposing the surface imagewise by means of the exposing unit.

The formation of the visible image by the development is specifically as follows: a toner layer is formed on a developing roller serving as the developer bearing member, the toner layer on the developing roller is conveyed so as to come into contact with a photoconductor drum serving as the latent image bearing member, a latent electrostatic image on the photoconductor drum is thereby developed, and a visible image is thus formed.

The toner is agitated by an agitating unit and mechanically supplied to a developer supplying member.

The toner supplied from the developer supplying member and then deposited on the developer bearing member is formed into a uniform thin layer and charged, by passing through the developer layer regulating member provided in such a manner as to touch the surface of the developer bearing member.

The latent electrostatic image formed on the latent image bearing member is developed in a developing region by attaching the charged toner thereto by means of the developing unit, and a toner image (visible image) is thus formed.

The visible image on the latent image bearing member (photoconductor) can be transferred by charging the latent image bearing member with the use of a transfer charger, which can be favorably performed by the transfer unit.

The visible image transferred to a recording medium (transfer target object) is fixed using a fixing device (fixing unit). Toners of each color may be separately fixed upon their transfer to the recording medium. Alternatively, the toners of each color may be fixed at one time, being in a laminated state.

The fixing device is not particularly limited and may be suitably selected according to the intended purpose. Preference is given to use of a know heating and pressurizing unit.

Examples of the heating and pressurizing unit include a combination of a heating roller and a pressurizing roller, and a combination of a heating roller, a pressurizing roller and an endless belt.

In general, it is preferred that the temperature at which the heating is performed by the heating and pressurizing unit be in the range of 80° C. to 200° C.

Next, the fundamental structure of an image forming apparatus (printer) according to an embodiment of the present invention will be explained in further detail, referring to the drawings.

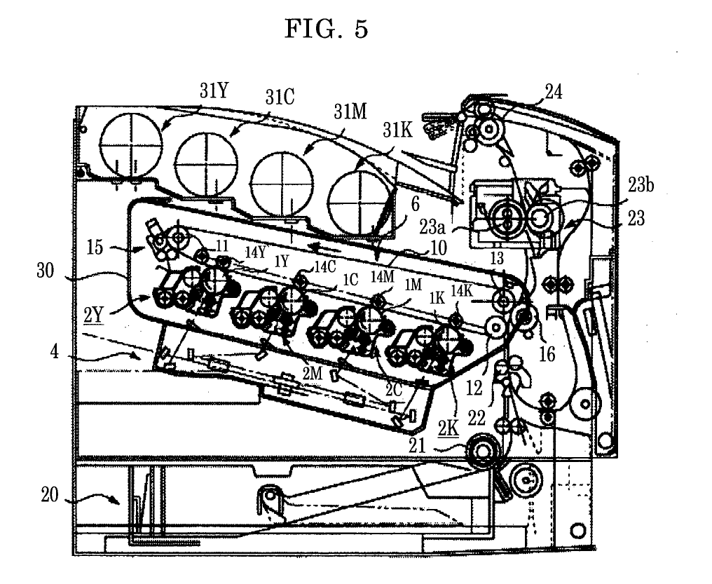

FIG. 5 is a schematic drawing showing the structure of an image forming apparatus according to an embodiment of the present invention.

Here, an embodiment in which the image forming apparatus is used as an electrophotographic image forming apparatus is explained.

The image forming apparatus forms a color image, using toners of four colors, i.e., yellow (hereinafter denoted by “Y”), cyan (hereinafter denoted by “C”), magenta (hereinafter denoted by “M”) and black (hereinafter denoted by “K”).

First of all, an explanation is given concerning the fundamental structure of an image forming apparatus (tandem-type image forming apparatus) including a plurality of latent image bearing members, in which the latent image bearing members are aligned in the moving direction of a surface moving member.

This image forming apparatus includes four photoconductors (i.e. 1Y, 1C, 1M and 1K) as the latent image bearing members. Note that although drum-like photoconductors are employed here as an example, belt-like photoconductors may be employed instead.

The photoconductors 1Y, 1C, 1M and 1K are rotationally driven in the direction of the arrows in the drawing, coming into contact with an intermediate transfer belt 10 that serves as the surface moving member.

The photoconductors 1Y, 1C, 1M and 1K are each produced by forming a photosensitive layer on a relatively thin cylindrical conductive substrate, and further forming a protective layer on the photosensitive layer. Additionally, an intermediate layer may be provided between the photosensitive layer and the protective layer.

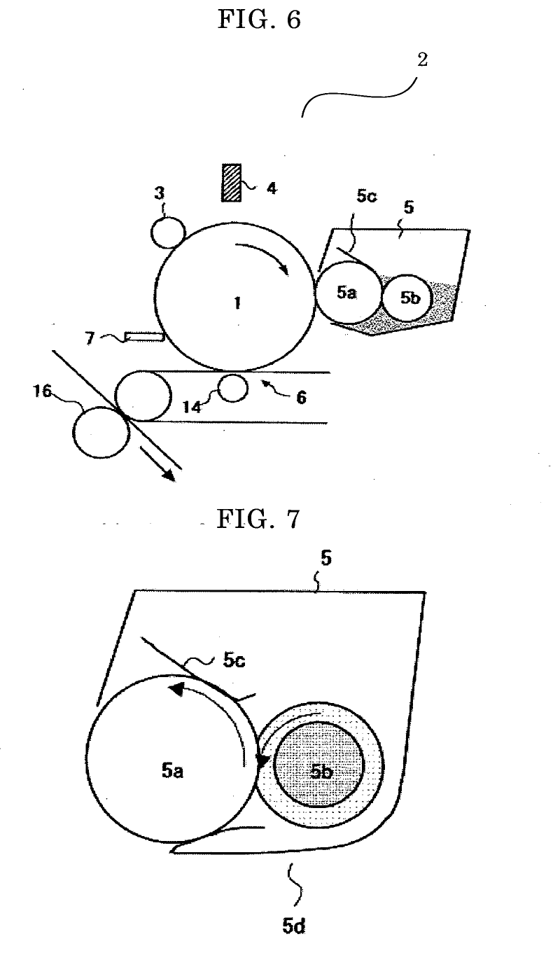

FIG. 6 is a schematic drawing showing the structure of an image forming portion 2 where a photoconductor is provided.

Note that since the structures of the photoconductors 1Y, 1C, 1M and 1K and their surroundings in image forming portions 2Y, 2C, 2M and 2K respectively are identical, only one image forming portion 2 is shown in the drawing, omitting the symbols Y, C, M and K that refer to differences in color.

Around the photoconductor 1, the following members are disposed in the order mentioned, with respect to the surface moving direction of the photoconductor 1: a charging device 3 as the charging unit, a developing device 5 as the developing unit, a transfer device 6 as the transfer unit configured to transfer a toner image on the photoconductor 1 to a recording medium or the intermediate transfer belt 10, and a cleaning device 7 configured to remove untransferred toner on the photoconductor 1.

Between the charging device 3 and the developing device 5, there is a space created such that light emitted from an exposing device 4 (which serves as the exposing unit configured to expose the charged surface of the photoconductor 1, based upon image data, so as to write a latent electrostatic image on the surface of the photoconductor 1) can pass through and reach as far as the photoconductor 1.

The charging device 3 charges the surface of the photoconductor 1 such that the surface has negative polarity.

The charging device 3 in the present embodiment includes a charging roller serving as a charging member which performs charging in accordance with a so-called contact or close charging method.

Specifically, this charging device 3 charges the surface of the photoconductor 1 by placing the charging roller in such a manner as to be in contact with or close to the surface of the photoconductor 1, and applying a bias of negative polarity to the charging roller.

Such a direct-current charging bias as makes the photoconductor 1 have a surface potential of −500 V is applied to the charging roller.

Additionally, a charging bias produced by superimposing an alternating-current bias onto a direct-current bias may be used as well.

The charging device 3 may be provided with a cleaning brush for cleaning the surface of the charging roller.

Also regarding the charging device 3, a thin film may be wound around both ends (with respect to the axial direction) of the circumferential surface of the charging roller, and this film may be placed in such a manner as to touch the surface of the photoconductor 1.

In this structure, the surface of the charging roller and the surface of the photoconductor 1 are very close to each other, with the distance between them being equivalent to the thickness of the film. Thus, discharge is generated between the surface of the charging roller and the surface of the photoconductor 1 by the charging bias applied to the charging roller, and the surface of the photoconductor 1 is charged by means of the discharge.

The surface of the photoconductor 1 thus charged is exposed by the exposing device 4, and a latent electrostatic image corresponding to each color is formed on the surface of the photoconductor 1.

This exposing device 4 writes a latent electrostatic image (which corresponds to each color) on the surface of the photoconductor 1 based upon image information (which corresponds to each color).

Note that although the exposing device 4 in the present embodiment is of laser type, an exposing device of other type, which includes an LED array and an image forming unit, may be employed as well.

Each toner supplied from toner bottles 31Y, 31C, 31M and 31K into the developing device 5 is conveyed by a developer supplying roller 5b and then borne on a developing roller 5a.

This developing roller 5a is conveyed to a region (developing region) that faces the photoconductor 1.

In the developing region, the surface of the developing roller 5a moves in a higher linear velocity than and in the same direction as the surface of the photoconductor 1.

Then, the toner on the developing roller 5a is supplied onto the surface of the photoconductor 1 in such a manner as to rub against the surface of the photoconductor 1. At this time, a developing bias of −300V is applied from a power source (not shown) to the developing roller 5a, and thus a developing electric field is formed in the developing region.

Between the latent electrostatic image on the photoconductor 1 and the developing roller 5a, electrostatic force which advances toward the latent electrostatic image acts on the toner borne on the developing roller 5a.

Thus, the toner on the developing roller 5a is attached to the latent electrostatic image on the photoconductor 1. By this attachment, the latent electrostatic image on the photoconductor 1 is developed into a toner image corresponding to each color.

The intermediate transfer belt 10 in the transfer device 6 is supported by three supporting rollers 11, 12 and 13 and is configured to move endlessly in the direction of the arrow in the drawing.

The toner images on the photoconductors 1Y, 1C, 1M and 1K are transferred by an electrostatic transfer method onto this intermediate transfer belt 10 such that the toner images are superimposed on one another.

The electrostatic transfer method may employ a structure with a transfer charger. Nevertheless, in this embodiment, a structure with a primary transfer roller 14, which causes less scattering of transferred timer, is employed.

Specifically, primary transfer rollers 14Y, 14C, 14M and 14K each serving as a component of the transfer device 6 are placed on the opposite side to the part of the intermediate transfer belt 10 which comes into contact with the photoconductors 1Y, 1C, 1M and 1K.

Here, the part of the intermediate transfer belt 10 pressed by the primary transfer rollers 14Y, 14C, 14M and 14K, and the photoconductors 1Y, 1C, 1M and 1K constitute respective primary transfer nip portions.

When the toner images on the photoconductors 1Y, 1C, 1M and 1K are transferred onto the intermediate transfer belt 10, a bias of positive polarity is applied to each primary transfer roller 14.

Accordingly, a transfer electric field is formed at each primary transfer nip portion, and the toner images on the photoconductors 1Y, 1C, 1M and 1K are electrostatically attached onto the intermediate transfer belt 10 and thusly transferred.

A belt cleaning device 15 for removing toner which remains on the surface of the intermediate transfer belt 10 is provided in the vicinity of the intermediate transfer belt 10.

Using a fur brush or a cleaning blade, this belt cleaning device 15 is configured to collect unnecessary toner attached to the surface of the intermediate transfer belt 10.

Parenthetically, the collected unnecessary toner is conveyed from inside the belt cleaning device 15 to a waste toner tank (not shown) by a conveyance unit (not shown).

At the part where the intermediate transfer belt 10 is supported by the supporting roller 13, a secondary transfer roller 16 is placed in such a manner as to be in contact with the intermediate transfer belt 10.

A secondary transfer nip portion is formed between the intermediate transfer belt 10 and the secondary transfer roller 16, and transfer paper as a recording medium is sent to this secondary transfer nip portion at predetermined timing.

This transfer paper is stored in a paper feed cassette 20 situated below (in FIG. 5) the exposing device 4, then the transfer paper is transferred to the secondary transfer nip portion by a paper feed roller 21, a pair of registration rollers 22 and the like.

At the secondary transfer nip portion, the toner images superimposed onto one another on the intermediate transfer belt 10 are transferred onto the transfer paper at one time.

At the time of this secondary transfer, a bias of positive polarity is applied to the secondary transfer roller 16, and the toner images on the intermediate transfer belt 10 are transferred onto the transfer paper by means of a transfer electric field formed by the application of the bias.

A heat fixing device 23 serving as the fixing unit is placed on the downstream side of the secondary transfer nip portion with respect to the direction in which the transfer paper is conveyed.

This heat fixing device 23 includes a heating roller 23a with a heater incorporated therein, and a pressurizing roller 23b for applying pressure.

The transfer paper which has passed through the secondary transfer nip portion receives heat and pressure, sandwiched between these rollers. This causes the toners on the transfer paper to melt, and a toner image is fixed to the transfer paper. The transfer paper to which the toner image has been fixed is discharged by a paper discharge roller 24 onto a paper discharge tray situated on an upper surface of the apparatus.

Regarding the developing device 5, the developing roller 5a serving as the developer bearing member is partially exposed from an opening of a casing of the developing device 5.

Also, in this embodiment, a one-component developer including no carrier is used.

The developing device 5 receives each of the toners supplied from the toner bottles 31Y, 31C, 31M and 31K (shown in FIG. 5) and stores it therein.

These toner bottles 31Y, 31C, 31M and 31K are detachably mountable to the main body of the image forming apparatus such that they can be separately replaced.

Due to such a structure, when any of the toners has run out, the corresponding toner bottle among the toner bottles 31Y, 31C, 31M and 31K can be replaced. Therefore, when any of the toners has run out, components other than the corresponding toner bottle, whose lifetimes have not ended, can continue being used, and thus the user can save costs.

FIG. 7 is a schematic drawing showing the structure of the developing device 5 shown in FIG. 6.

The developer (toner) housed in a developer storing container is conveyed to a nip portion formed between the developing roller 5a (which serves as the developer bearing member configured to bear on its surface the developer to be supplied to the photoconductor 1) and the developer supplying roller 5b (which serves as the developer supplying member) while being agitated by the developer supplying roller 5b. At this time, the developer supplying roller 5b and the developing roller 5a rotate in opposite directions to each other (counter rotation) at the nip portion.

The amount of the toner on the developing roller 5a is regulated by a regulatory blade 5c (which serves as the developer layer regulating member) provided in such a manner as to touch the developing roller 5a, and a toner thin layer is thus formed on the developing roller 5a.

Also, the toner is rubbed at the nip portion between the developer supplying roller 5b and the developing roller 5a and at the portion between the regulatory blade 5c and the developing roller 5a, and controlled so as to have an appropriate charge amount.

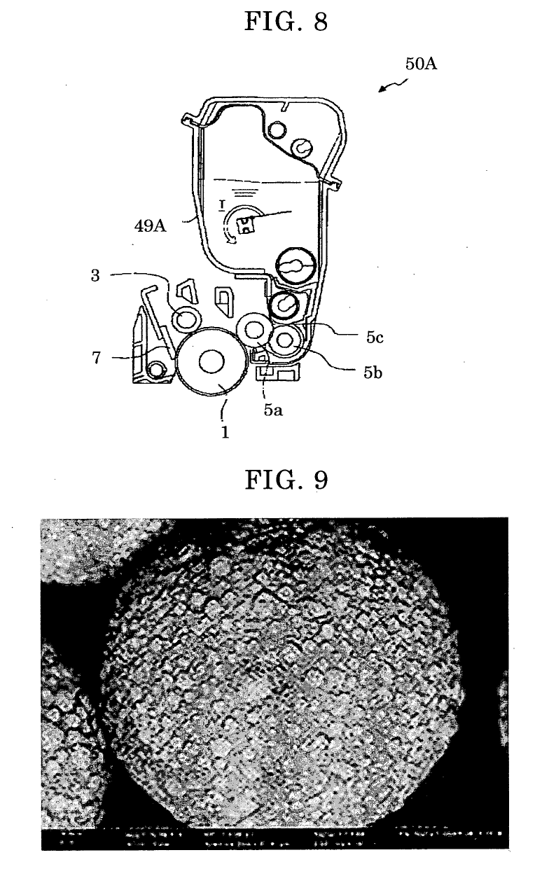

FIG. 8 is a schematic drawing showing the structure of a process cartridge. “49A” denotes a developer storing container.

The developer according to the present invention can, for example, be used in an image forming apparatus which is provided with a process cartridge 50A shown in FIG. 8.

In the present invention, among components such as a latent electrostatic image bearing member, a latent electrostatic image charging unit and a developing unit, a plurality of members constitute a single unit as a process cartridge, and this process cartridge is constructed in such a manner as to be detachably mountable to the main body of an image forming apparatus such as a copier or printer.

The process cartridge shown in FIG. 8 includes a latent electrostatic image bearing member, a latent electrostatic image charging unit, and the developing unit explained in relation to FIG. 7.

### EXAMPLES

The following describes Examples of the present invention. It should, however, be noted that the scope of the present invention is not confined to these Examples. In the Examples, the term “part(s)” means “part(s) by mass”, and the symbol “%” used in relation to concentration means “% by mass”.

### <Particle Size Distribution of Toner>

As a measuring apparatus for measuring the particle size distribution of the toner, COULTER COUNTER TA-II, COULTER MULTISIZER II (both manufactured by Coulter Corporation), etc. may be used, for example. The following describes a method of measuring the particle size distribution.

Firstly, 0.1 mL to 5 mL of a surfactant (preferably alkylbenzene sulfonate) was added as a dispersant into 100 mL to 150 mL of an electrolytic aqueous solution. Here, the electrolytic aqueous solution was an approximately 1% NaCl aqueous solution prepared using primary sodium chloride; specifically, ISOTON-II (manufactured by Coulter Corporation) was used as the electrolytic aqueous solution. Subsequently, 2 mg to 20 mg of a measurement sample was added. The electrolytic aqueous solution in which the sample was suspended was subjected to dispersion treatment for 1 minute to 3 minutes using an ultrasonic dispersion apparatus. Then, by means of the measuring apparatus, with an aperture of 100 μm employed, the volume and the number of toner (toner particles) were measured, and the volume distribution and the number distribution were calculated. The volume average particle diameter and the number average particle diameter of the toner were calculated from the obtained distributions.

As channels, the following 13 channels were used: a channel of 2.00 μm or greater, but less than 2.52 μm; a channel of 2.52 μm or greater, but less than 3.17 μm; a channel of 3.17 μm or greater, but less than 4.00 μm; a channel of 4.00 μm or greater, but less than 5.04 μm; a channel of 5.04 μm or greater, but less than 6.35 μm; a channel of 6.35 μm or greater, but less than 8.00 μm; a channel of 8.00 μm or greater, but less than 10.08 μm; a channel of 10.08 μm or greater, but less than 12.70 μm; a channel of 12.70 μm or greater, but less than 16.00 μm; a channel of 16.00 μm or greater, but less than 20.20 μm; a channel of 20.20 μm or greater, but less than 25.40 μm; a channel of 25.40 μm or greater, but less than 32.00 μm; and a channel of 32.00 μm or greater, but less than 40.30 μm. Particles having diameters which were equal to or greater than 2.00 μm, but less than 40.30 μm were targeted.

### <Average Circularity>

As a method of measuring the toner particle shape, it is appropriate to employ an optical sensing zone method in which a particle-containing suspension is passes through a sensing zone of an imaging unit on a flat plate, and images of particles are optically sensed with a CCD camera and analyzed. The value obtained by dividing the circumferential lengths of equivalent circles of equal projected areas (obtained in this method) by the circumferential lengths of the actual particles was defined as the average circularity.

This value was measured as the average circularity, using the flow-type particle image analyzer FPIA-2000. The following is a specific measuring method: 0.1 mL to 0.5 mL of a surfactant (alkylbenzene sulfonate) was added as a dispersant into 100 mL to 150 mL of water (placed in a container) from which solid impurities had previously been removed; then approximately 0.1 g to approximately 0.5 g of a measurement sample was added. The suspension in which the sample was dispersed was subjected to dispersion treatment for 1 minute to 3 minutes using an ultrasonic dispersion apparatus, the shape and the distribution of the toner (toner particles) were measured by means of the analyzer, adjusting the concentration of the dispersion liquid such that the number of toner particles was in the range of 3,000 per microliter to 10,000 per microliter, and the average circularity was thus obtained.

### <Volume Average Particle Diameter of Resin Fine Particles>

The volume average particle diameter of resin fine particles can be measured using a Nanotrac Particle Size Measuring Apparatus (UPA-EX150, manufactured by NIKKISO CO., LTD.; dynamic light scattering method/laser Doppler method). The following is a specific measuring method: the concentration of a dispersion liquid in which resin fine particles were dispersed was adjusted to a measurement concentration range, and the measurement was carried out; on that occasion, background measurement was previously performed using only the dispersion solvent of the dispersion liquid. This measuring method enabled the measurement of the volume average particle diameter, covering the range of several tens of nanometers to several micrometers, where the volume average particle diameter of the resin fine particles used in the present invention belongs.

### <Molecular Weight>

The molecular weights of the polyester resin, the vinyl copolymer resin, etc. used were measured by ordinary GPC (gel permeation chromatography) under the following conditions.
Apparatus: HLC-8220GPC (manufactured by TOSOH CORPORATION)
Column: TSK GEL SUPER HZM-M×3
Temperature: 40° C.
Solvent: THF (tetrahydrofuran)
Flow rate: 0.35 mL/min
Sample: 0.01 mL of a sample having a concentration of 0.05% to 0.6% was injected.

Based upon the molecular weight distribution of the toner resin measured under the above conditions, the weight average molecular weight (Mw) was calculated, using a molecular weight calibration curve produced with monodisperse polystyrene standard samples. Regarding these monodisperse polystyrene standard samples, 10 samples respectively having the following molecular weights were used: 5.8×100, 1.085×10,000, 5.95×10,000, 3.2×100,000, 2.56×1,000,000, 2.93×1,000, 2.85×10,000, 1.48×100,000, 8.417×100,000 and 7.5×1,000,000.

### <Glass Transition Temperature (Tg) and Heat Absorption Amount>

The glass transition temperatures of the polyester resin, the vinyl copolymer resin, etc. used were measured using a differential scanning calorimeter (DSC-6220R, manufactured by Seiko Instruments Inc.).

Firstly, a sample was heated from room temperature to 150° C. at a temperature increase rate of 10° C./min. Thereafter, the sample was left to stand at 150° C. for 10 minutes, then cooled to room temperature and subsequently left to stand for 10 minutes. After that, the sample was again heated to 150° C. at a temperature increase rate of 10° C./min, and a DSC measurement was carried out. Using an analysis system in the differential scanning calorimeter, the Tg of the sample was calculated based upon the point where the base line meets the tangent to an endothermic curve in the vicinity of the Tg.

Also, the heat absorption amounts and the melting points of a release agent, a crystalline resin, etc. could be similarly measured. The heat absorption amount of a sample was measured by calculating the peak area of a measured endothermic peak. Generally, a release agent used inside a toner melts at a temperature lower than the fixation temperature of the toner, and the melting heat generated during the melting is shown as an endothermic peak. Depending upon the release agent, transition heat is generated (due to phase transition with respect to a solid phase) as well as the melting heat; in the present invention, the total absorption amount of the melting heat and the transition heat is defined as the absorption amount of the melting heat.

### <Measurement of Solid Content Concentration>

The solid content concentration of an oil phase was measured as follows.

Approximately 2 g of an oil phase was placed within 30 seconds on an aluminum dish (approximately 1 g to approximately 3 g) whose mass had been accurately measured using a balance, and the mass of the oil phase placed thereon was accurately measured using a balance. The aluminum dish with the oil phase was placed in an oven (150° C.) for 1 hour, and the solvent was evaporated. Thereafter, the aluminum dish with the oil phase was removed from the oven, then left to stand and thereby cooled, and the total mass of the aluminum dish and the oil phase solid content was measured using an electronic balance. The mass of the oil phase solid content was calculated by subtracting the mass of the aluminum dish from the total mass of the aluminum dish and the oil phase solid content, and the solid content concentration of the oil phase was calculated by dividing the mass of the oil phase solid content by the mass of the oil phase placed on the aluminum dish. The amount ratio of the solvent to the solid content of the oil phase was the value obtained by dividing the value (mass of the solvent) (which was obtained by subtracting the mass of the oil phase solid content from the mass of the oil phase) by the mass of the oil phase solid content.

### <Measurement of Acid Value>

The acid value of a resin was measured in accordance with JIS K1557-1970. The following is a specific measuring method.

Using a balance, the amount of a sample as a pulverized product was adjusted to approximately 2 g (W(g)).

The sample was poured into a 200 mL conical flask, then 100 mL of a mixed solution of toluene and ethanol (with the ratio of the toluene to the ethanol being 2:1) was added. The sample was dissolved in the mixed solution for 5 hours, then a phenolphthalein solution was added as an indicator.

Using a 0.1N potassium hydroxide alcohol solution, the solution obtained as described above was titrated with a burette. The amount of the KOH solution at this time was denoted by S (mL). A blank test was carried out, and the amount of the KOH solution at this time was denoted by B (mL).

The acid value was calculated from the following equation.

Acid value=[(S−B)×f×5.61]/W
(f: factor of KOH solution)

### —Long Sides of Protruding Portions and Coverage of Protruding Portions—

The toner was observed using a scanning electron microscope (SEM), and the lengths of long sides of protruding portions and the coverage of the protruding portions with respect to the toner surface were calculated based upon an SEM image obtained.

Referring to FIG. 1, the following explains a method of calculating the lengths of the long sides of the protruding portions and the coverage of the protruding portions, mentioned in Examples.

### <Coverage>

(1) The shortest distance between two parallel lines touching a toner particle was measured, with the points of tangency being denoted by A and B respectively.
(2) Based upon the area of a circle whose diameter was equivalent to the length of the line segment AO (O denotes the central point of the line segment AB) and upon the area of protruding portions present in the circle, the coverage of the protruding portions with respect to the toner surface was calculated.
(3) The coverage of the protruding portions was calculated as described above, regarding 100 or more toner particles, then the average value was calculated.

### <Average Length of Long Sides of Protruding Portions>

(1) The average length of the long sides of the protruding portions was determined by measuring the lengths of the long sides of 100 or more protruding portions with respect to 100 or more toner particles, then calculating the average value.

In Examples, 100 toner particles were selected, the length of the long side of one protruding portion per toner particle was measured, and this measurement was carried out on those 100 toner particles selected.

(2) The Image Analysis Type Particle Size Distribution Measuring Software “MAC-VIEW” (manufactured by Mountech Co., Ltd.) was used to measure the area of the protruding portions and the lengths of the long sides of the protruding portions.

### <Production Method of Resin Dispersion 1>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed solution of 200 parts of a styrene monomer and 4.2 parts of n-octanethiol was dripped for 90 minutes, then a polymerization reaction was effected keeping the temperature at 80° C. for 60 minutes.

Thereafter, cooling was carried out, and white Resin Dispersion 1 (which had a volume average particle diameter of 135 nm) was thus obtained. Two milliliters of Resin Dispersion 1 was placed in a Petri dish, then the dispersion medium was evaporated, and dried matter was thus obtained. The dried matter had a number average molecular weight of 8,300, a weight average molecular weight of 16,900 and a glass transition temperature (Tg) of 83° C.

### <Production Method of Resin Dispersion 2>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed solution of 170 parts of a styrene monomer, 30 parts of butyl acrylate and 4.2 parts of n-octanethiol was dripped for 90 minutes, then a polymerization reaction was effected keeping the temperature at 80° C. for 60 minutes.

Thereafter, cooling was carried out, and white Resin Dispersion 2 (which had a volume average particle diameter of 135 nm) was thus obtained. Two milliliters of Resin Dispersion 2 was placed in a Petri dish, then the dispersion medium was evaporated, and dried matter was thus obtained. The dried matter had a number average molecular weight of 8,600, a weight average molecular weight of 17,300 and a glass transition temperature (Tg) of 55° C.

### <Production Method of Resin Dispersion 3>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.7 parts of potassium persulfate was dissolved in 108 parts of ion-exchange water was added. Fifteen minutes after, a monomer mixed solution of 160 parts of a styrene monomer and 40 parts of methyl methacrylate was dripped for 90 minutes, then a polymerization reaction was effected keeping the temperature at 80° C. for 60 minutes.

Thereafter, cooling was carried out, and white Resin Dispersion 3 (which had a volume average particle diameter of 100 nm) was thus obtained. Two milliliters of Resin Dispersion 3 was placed in a Petri dish, then the dispersion medium was evaporated, and dried matter was thus obtained. The dried matter had a number average molecular weight of 60,000, a weight average molecular weight of 215,500 and a glass transition temperature (Tg) of 99° C.

### <Production Method of Resin Dispersion 4>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.5 parts of potassium persulfate was dissolved in 98 parts of ion-exchange water was added. Fifteen minutes after, a monomer mixed solution of 160 parts of a styrene monomer and 40 parts of Compound 1 was dripped for 90 minutes, then a polymerization reaction was effected keeping the temperature at 80° C. for 60 minutes.

Thereafter, cooling was carried out, and white Resin Dispersion 4 (which had a volume average particle diameter of 115 nm) was thus obtained. Two milliliters of Resin Dispersion 4 was placed in a Petri dish, then the dispersion medium was evaporated, and dried matter was thus obtained. The dried matter had a number average molecular weight of 98,400, a weight average molecular weight of 421,900 and a glass transition temperature (Tg) of 70° C.

### <Production Method of Resin Dispersion 5>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.7 parts of potassium persulfate was dissolved in 108 parts of ion-exchange water was added. Fifteen minutes after, a monomer mixed solution of 160 parts of a styrene monomer and 40 parts of methyl methacrylate was dripped for 90 minutes, then a polymerization reaction was effected keeping the temperature at 80° C. for 60 minutes.

Thereafter, cooling was carried out, and white Resin Dispersion 5 (which had a volume average particle diameter of 100 nm) was thus obtained. Two milliliters of Resin Dispersion was placed in a Petri dish, then the dispersion medium was evaporated, and dried matter was thus obtained. The dried matter had a number average molecular weight of 60,000, a weight average molecular weight of 215,500 and a glass transition temperature (Tg) of 99° C.

### <Production Method of Resin Dispersion 6>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.5 parts of potassium persulfate was dissolved in 101 parts of ion-exchange water was added. Fifteen minutes after, a monomer mixed solution of 170 parts of a styrene monomer and 30 parts of butyl acrylate was dripped for 90 minutes, then a polymerization reaction was effected keeping the temperature at 80° C. for 60 minutes.

Thereafter, cooling was carried out, and white Resin Dispersion 6 (which had a volume average particle diameter of 113 nm) was thus obtained. Two milliliters of Resin Dispersion 6 was placed in a Petri dish, then the dispersion medium was evaporated, and dried matter was thus obtained. The dried matter had a number average molecular weight of 68,700, a weight average molecular weight of 317,600 and a glass transition temperature (Tg) of 75° C.

### <Production Method of Resin Dispersion 7>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 102 parts of ion-exchange water was added. Fifteen minutes after, a monomer mixed solution of 184.6 parts of a styrene monomer, 15 parts of butyl acrylate and 0.5 parts of divinylbenzene was dripped for 90 minutes, then a polymerization reaction was effected keeping the temperature at 80° C. for 60 minutes.

Thereafter, cooling was carried out, and white Resin Dispersion 7 (which had a volume average particle diameter of 79 nm) was thus obtained. Two milliliters of Resin Dispersion 7 was placed in a Petri dish, then the dispersion medium was evaporated, and dried matter was thus obtained. The dried matter had a number average molecular weight of 33,900, a weight average molecular weight of 160,800 and a glass transition temperature (Tg) of 87° C.

### <Production Method of Resin Dispersion 8>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.5 parts of potassium persulfate was dissolved in 101 parts of ion-exchange water was added. Fifteen minutes after, a monomer mixed solution of 169 parts of a styrene monomer, 30 parts of butyl acrylate and 1 part of divinylbenzene was dripped for 90 minutes, then a polymerization reaction was effected keeping the temperature at 80° C. for 60 minutes.

Thereafter, cooling was carried out, and white Resin Dispersion 8 (which had a volume average particle diameter of 100 nm) was thus obtained. Two milliliters of Resin Dispersion 8 was placed in a Petri dish, then the dispersion medium was evaporated, and dried matter was thus obtained. The dried matter had a number average molecular weight of 31,300, a weight average molecular weight of 88,300 and a glass transition temperature (Tg) of 75° C.

### <Production Method of Resin Dispersion 9>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, a monomer mixed solution of 200 parts of a styrene monomer and 14 parts of n-octanethiol was dripped for 90 minutes, then a polymerization reaction was effected keeping the temperature at 80° C. for 60 minutes.

Thereafter, cooling was carried out, and white Resin Dispersion 9 (which had a volume average particle diameter of 143 nm) was thus obtained. Two milliliters of Resin Dispersion 9 was placed in a Petri dish, then the dispersion medium was evaporated, and dried matter was thus obtained. The dried matter had a number average molecular weight of 2,700, a weight average molecular weight of 6,100 and a glass transition temperature (Tg) of 44° C.

### <Production Method of Resin Dispersion 10>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.6 parts of potassium persulfate was dissolved in 104 parts of ion-exchange water was added. Fifteen minutes after, 200 parts of a styrene monomer was dripped for 90 minutes, then a polymerization reaction was effected keeping the temperature at 80° C. for 60 minutes.

Thereafter, cooling was carried out, and white Resin Dispersion 10 (which had a volume average particle diameter of 100 nm) was thus obtained. Two milliliters of Resin Dispersion 10 was placed in a Petri dish, then the dispersion medium was evaporated, and dried matter was thus obtained. The dried matter had a number average molecular weight of 61,700, a weight average molecular weight of 215,200 and a glass transition temperature (Tg) of 101° C.

### <Production Method of Resin Dispersion 11>

The polyester resin dispersion RTP-2 (manufactured by TOYOBO CO., LTD.) was used.

### <Production Method of Resin Dispersion 12>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.5 parts of potassium persulfate was dissolved in 98 parts of ion-exchange water was added. Fifteen minutes after, a monomer mixed solution of 130 parts of a styrene monomer and 70 parts of Compound 1 was dripped for 90 minutes, then a polymerization reaction was effected keeping the temperature at 80° C. for 60 minutes.

Thereafter, cooling was carried out, and white Resin Dispersion 12 (which had a volume average particle diameter of 115 nm) was thus obtained. Two milliliters of Resin Dispersion 12 was placed in a Petri dish, then the dispersion medium was evaporated, and dried matter was thus obtained. The dried matter had a number average molecular weight of 87,600, a weight average molecular weight of 391,700 and a glass transition temperature (Tg) of 48° C.

### <Production Method of Resin Dispersion 13>

In a reaction container equipped with a condenser tube, a stirrer and a nitrogen-introducing tube, 0.7 parts of sodium dodecyl sulfate and 498 parts of ion-exchange water were placed. With stirring, the sodium dodecyl sulfate was dissolved in the ion-exchange water, increasing the temperature to 80° C., and then a solution in which 2.8 parts of potassium persulfate was dissolved in 111 parts of ion-exchange water was added. Fifteen minutes after, a monomer mixed solution of 130 parts of a styrene monomer and 70 parts of methyl methacrylate was dripped for 90 minutes, then a polymerization reaction was effected keeping the temperature at 80° C. for 60 minutes.

Thereafter, cooling was carried out, and white Resin Dispersion 13 (which had a volume average particle diameter of 122 nm) was thus obtained. Two milliliters of Resin Dispersion 13 was placed in a Petri dish, then the dispersion medium was evaporated, and dried matter was thus obtained. The dried matter had a number average molecular weight of 61,900, a weight average molecular weight of 183,500 and a glass transition temperature (Tg) of 99° C.

### [Production Method of Polymerization Toner]

### <Synthesis of Non-Crystalline Polyester>

### (Polyester 1)

In a reaction container equipped with a condenser tube, a stirrer and a nitrogen-introducing tube, 229 parts of an ethylene oxide (2 mol) adduct of bisphenol A, 529 parts of a propylene oxide (3 mol) adduct of bisphenol A, 208 parts of terephthalic acid, 46 parts of adipic acid and 2 parts of dibutyltin oxide were placed. Subsequently, the ingredients were reacted together for 8 hours at normal pressure and at 230° C., then further reacted together for 5 hours at a reduced pressure of 10 mmHg to 15 mmHg. Thereafter, 44 parts of trimellitic anhydride was poured into the reaction container, then the ingredients were reacted together for 2 hours at normal pressure and at 180° C., and Polyester 1 was thus synthesized. Polyester 1 had a number average molecular weight of 2,500, a weight average molecular weight of 6,700, a glass transition temperature (Tg) of 43° C. and an acid value of 25 mgKOH/g.

### (Polyester 2)

In a reaction container equipped with a condenser tube, a stirrer and a nitrogen-introducing tube, 264 parts of an ethylene oxide (2 mol) adduct of bisphenol A, 523 parts of a propylene oxide (2 mol) adduct of bisphenol A, 123 parts of terephthalic acid, 173 parts of adipic acid and 1 part of dibutyltin oxide were placed. Subsequently, the ingredients were reacted together for 8 hours at normal pressure and at 230° C., then further reacted together for 8 hours at a reduced pressure of 10 mmHg to 15 mmHg. Thereafter, 26 parts of trimellitic anhydride was poured into the reaction container, then the ingredients were reacted together for 2 hours at normal pressure and at 180° C., and Polyester 2 was thus synthesized. Polyester 2 had a number average molecular weight of 4,000, a weight average molecular weight of 47,000, a glass transition temperature (Tg) of 65° C. and an acid value of 12 mgKOH/g.

### (Polyester 3)

In a reaction container equipped with a condenser tube, a stirrer and a nitrogen-introducing tube, 270 parts of an ethylene oxide (2 mol) adduct of bisphenol A, 497 parts of a propylene oxide (2 mol) adduct of bisphenol A, 110 parts of terephthalic acid, 102 parts of isophthalic acid, 44 parts of adipic acid and 2 parts of dibutyltin oxide were placed. Subsequently, the ingredients were reacted together for 9 hours at normal pressure and at 230° C., then further reacted together for 7 hours at a reduced pressure of 10 mmHg to 18 mmHg. Thereafter, 40 parts of trimellitic anhydride was poured into the reaction container, then the ingredients were reacted together for 2 hours at normal pressure and at 180° C., and Polyester 3 was thus synthesized. Polyester 3 had a number average molecular weight of 3,000, a weight average molecular weight of 8,600, a glass transition temperature (Tg) of 49° C. and an acid value of 22 mgKOH/g.

### —Synthesis of Isocyanate-Modified Polyester 1—

In a reaction container equipped with a condenser tube, a stirrer and a nitrogen-introducing tube, 682 parts of an ethylene oxide (2 mol) adduct of bisphenol A, 81 parts of a propylene oxide (2 mol) adduct of bisphenol A, 283 parts of terephthalic acid, 22 parts of trimelllitic anhydide and 2 parts of dibutyltin oxide were placed. Subsequently, the ingredients were reacted together for 8 hours at normal pressure and at 230° C., then further reacted together for 5 hours at a reduced pressure of 10 mmHg to 15 mmHg, and Intermediate Polyester 1 was thus synthesized. Intermediate Polyester 1 had a number average molecular weight of 2,200, a weight average molecular weight of 9,700, a glass transition temperature (Tg) of 54° C., an acid value of 0.5 mgKOH/g and a hydroxyl value of 52 mgKOH/g.

Next, in a reaction container equipped with a condenser tube, a stirrer and a nitrogen-introducing tube, 410 parts of Intermediate Polyester 1, 89 parts of isophorone diisocyanate and 500 parts of ethyl acetate were placed. Subsequently, the ingredients were reacted together for 5 hours at 100° C., and Isocyanate-modified Polyester 1 was thus obtained.

### —Production of Master Batch—

Using a Henschel mixer, 40 parts of carbon black (REGAL 400R, manufactured by Cabot Corporation), 60 parts of a polyester resin (RS-801, manufactured by Sanyo Chemical Industries, Ltd.; acid value: 10 mgKOH/g, weight average molecular weight (Mw): 20,000, glass transition temperature (Tg): 64° C.) as a binder resin, and 30 parts of water were mixed together, and a mixture in which water had soaked into a pigment aggregate was thus obtained. This mixture was kneaded for 45 minutes, using a double roll mill with the roll surface temperature being set at 130° C., then the kneaded mixture was pulverized so as to have a size of 1 mm, using a pulverizer, and Master Batch 1 was thus obtained.

### Example 1

### Oil Phase Producing Step

In a container equipped with a stirring rod and a thermometer, 545 parts of Polyester 2, 181 parts of a paraffin wax (melting point: 74° C.) and 1,450 parts of ethyl acetate were placed. While the ingredients were being stirred, the temperature was increased to 80° C. The temperature was kept at 80° C. for 5 hours, and then cooled to 30° C. in 1 hour. Subsequently, 500 parts of Master Batch 1 and 100 parts of ethyl acetate were poured into the container, which was followed by mixing for 1 hour, and Raw Material Solution 1 was thus obtained.

Then 1,500 parts of Raw Material Solution 1 was moved into another container, and the pigment and the wax were dispersed using a bead mill (ULTRA VISCO MILL, manufactured by AIMEX CO., Ltd.) under the following conditions: the liquid sending rate was 1 kg/hr, the disc circumferential velocity was 6 m/sec, zirconia beads of 0.5 mm each were supplied so as to occupy 80% by volume, and the ingredients were passed three times. Subsequently, 655 parts of a 66% ethyl acetate solution of Polyester 2 was added, and the mixture was passed once using the bead mill under the above conditions, and Pigment and Wax Dispersion Liquid 1 was thus obtained.

Using T.K. HOMO MIXER (manufactured by Tokushu Kika Kogyo Co., Ltd.), 976 parts of Pigment and Wax Dispersion Liquid 1 was mixed at a rotational speed of 5,000 rpm for 1 minute. Thereafter, 88 parts of Isocyanate-modified Polyester 1 was added, then the ingredients were mixed using T.K. HOMO MIXER (manufactured by Tokushu Kika Kogyo Co., Ltd.) at a rotational speed of 5,000 rpm for 1 minute, and Oil Phase 1 thus was obtained. Oil Phase 1 had a solid content of 52.0% by mass, and the amount of the ethyl acetate with respect to the solid content was 92% by mass.

### <Preparation of Aqueous Phase>

Nine hundred and seventy parts of ion-exchange water, 40 parts of a 25% aqueous dispersion liquid of organic resin fine particles (a copolymer of styren-methacrylic acid-butyl acrylate-sodium salt of methacrylic acid ethylene oxide adduct sulfate ester) for dispersion stability, 95 parts of a 48.5% aqueous solution of sodium dodecyl diphenyl ether disulfonate, and 98 parts of ethyl acetate were mixed and stirred. The mixture had a pH of 6.2. Then the pH was adjusted to 9.5 by dripping a 10% sodium hydroxide aqueous solution, and Aqueous Phase 1 was thus obtained.

### <Core Particle Producing Step>

To Oil Phase 1 was added 1,200 parts of Aqueous phase 1. Then the liquid temperature was adjusted to the range of 20° C. to 23° C. by cooling with a water bath so as to suppress temperature increase caused by the shear heat of a mixer; while doing so, the ingredients were mixed for 2 minutes using T.K. HOMO MIXER with its rotational speed adjusted to the range of 8,000 rpm to 15,000 rpm, then the ingredients were mixed for 10 minutes using a three-one motor equipped with anchor blades, with its rotational speed adjusted to the range of 130 rpm to 350 rpm, and Core Particle Slurry 1, in which droplets of the oil phase to form core particles were dispersed in the aqueous phase, was thus obtained.

### <Formation of Protruding Portions>

Core Particle Slurry 1 was stirred using a three-one motor equipped with anchor blades, with its rotational speed adjusted to the range of 130 rpm to 350 rpm; while doing so, a mixture (solid content concentration: 15%) of 106 parts of Resin Dispersion 1 and 71 parts of ion-exchange water was dripped for 3 minutes, with the liquid temperature set at 22° C. After the dripping, stirring was continued for 30 minutes with the rotational speed being adjusted to the range of 200 rpm to 450 rpm, and Composite Particle Slurry 1 was thus obtained. When 1 mL of Composite Particle Slurry 1 was collected, diluted to 10 mL and then centrifuged, the supernatant liquid was transparent.

### <Solvent Removing Step>

In a container equipped with a stirrer and a thermometer, Composite Particle Slurry 1 was placed, then the solvent was removed at 30° C. in 8 hours, while the ingredients were being stirred, and Dispersion Slurry 1 was thus obtained. When a small amount of Dispersion Slurry 1 was placed on a glass slide and observed using an optical microscope at a magnification of 200 times, with cover glass being placed in between, the presence of uniform colored particles was confirmed. Also, when 1 mL of Dispersion Slurry 1 was collected, diluted to 10 mL and then centrifuged, the supernatant liquid was transparent.

### <Washing and Drying Step>

After 100 parts of Dispersion Slurry 1 was filtered under reduced pressure, the following operations were carried out.

(1) To the filter cake, 100 parts of ion-exchange water was added, then mixing was carried out using T.K. HOMO MIXER (rotational speed: 12,000 rpm, length of time: 10 minutes), and subsequently filtration was carried out.
(2) To the filter cake obtained by (1), 900 parts of ion-exchange water was added, then mixing was carried out using T.K. HOMO MIXER (rotational speed: 12,000 rpm, length of time: 30 minutes) with the provision of ultrasonic vibration, and subsequently filtration was carried out under reduced pressure. This process was repeated such that the electrical conductivity of the reslurry liquid became 10 μS/cm or less.
(3) In order that the pH of the reslurry liquid obtained by (2) should stand at 4, 10% hydrochloric acid was added, then stirring was carried out for 30 minutes using a three-one motor, and subsequently filtration was carried out.
(4) To the filter cake obtained by (3), 100 parts of ion-exchange water was added, then mixing was carried out using T.K. HOMO MIXER (rotational speed: 12,000 rpm, length of time: 10 minutes), and subsequently filtration was carried out. This process was repeated such that the electrical conductivity of the reslurry liquid became 10 μS/cm or less, and Filter Cake 1 was thus obtained.

Filter Cake 1 was dried at 45° C. for 48 hours using a wind circulation dryer and then sieved using a mesh with a sieve mesh size of 75 μm, and Toner Base 1 was thus obtained. When Toner Base 1 was observed using a scanning electron microscope, it was confirmed that the vinyl resin was uniformly attached to the surfaces of the core particles.

### Example 2

A toner of Example 2 was produced in the same manner as in Example 1 except that Polyester 3 was used instead of Polyester 2.

### Example 3

A toner of Example 3 was produced in the same manner as in Example 1 except that Polyester 3 was used instead of Polyester 2 and that Resin Dispersion 2 was used instead of Resin Dispersion 1.

### Example 4

A toner of Example 4 was produced in the same manner as in Example 1 except that Polyester 3 was used instead of Polyester 2 and that Resin Dispersion 3 was used instead of Resin Dispersion 1.

### Example 5

A toner of Example 5 was produced in the same manner as in Example 1 except that Polyester 3 was used instead of Polyester 2 and that Resin Dispersion 4 was used instead of Resin Dispersion 1.

### Example 6

A toner of Example 6 was produced in the same manner as in Example 1 except that Polyester 3 was used instead of Polyester 2 and that Resin Dispersion 5 was used instead of Resin Dispersion 1.

### Example 7

A toner of Example 7 was produced in the same manner as in Example 1 except that Polyester 3 was used instead of Polyester 2 and that Resin Dispersion 6 was used instead of Resin Dispersion 1.

### Example 8

A toner of Example 8 was produced in the same manner as in Example 1 except that Polyester 3 was used instead of Polyester 2 and that Resin Dispersion 7 was used instead of Resin Dispersion 1.

### Example 9

A toner of Example 9 was produced in the same manner as in Example 1 except that Polyester 3 was used instead of Polyester 2 and that Resin Dispersion 8 was used instead of Resin Dispersion 1.

### Example 10

A toner of Example 10 was produced in the same manner as in Example 1 except that Polyester 3 was used instead of Polyester 2 and that Isocyanate-modified Polyester 1 was not added.

### Example 11

A toner of Example 11 was produced in the same manner as in Example 1 except that Polyester 1 was used instead of Polyester 2.

### Example 12

A toner of Example 12 was produced in the same manner as in Example 1 except that Polyester 3 was used instead of Polyester 2 and that Resin Dispersion 9 was used instead of Resin Dispersion 1.

### Example 13

A toner of Example 13 was produced in the same manner as in Example 1 except that Polyester 3 was used instead of Polyester 2 and that Resin Dispersion 10 was used instead of Resin Dispersion 1.

### Comparative Example 1

A toner of Comparative Example 1 was produced in the same manner as in Example 1 except that Resin Dispersion 1 was not added.

### Comparative Example 2

A toner of Comparative Example 2 was produced in the same manner as in Example 1 except that Polyester 3 was used instead of Polyester 2 and that Resin Dispersion 11 was used instead of Resin Dispersion 1.

### Comparative Example 3

A toner of Comparative Example 3 was produced in the same manner as in Example 1 except that Polyester 3 was used instead of Polyester 2, that the amount of Resin Dispersion 1 was changed from 106 parts to 530 parts and that 105 parts of the 48.5% aqueous solution of sodium dodecyl diphenyl ether disulfonate was added simultaneously with the addition of Resin Dispersion 1.

### Comparative Example 4

A toner of Comparative Example 4 was produced in the same manner as in Example 1 except that Polyester 3 was used instead of Polyester 2 and that the amount of the 48.5% aqueous solution of sodium dodecyl diphenyl ether disulfonate contained in Aqueous Phase 1 was changed from 95 parts to 200 parts.

### Comparative Example 5

A toner of Comparative Example 5 was produced in the same manner as in Example 1 except that Polyester 3 was used instead of Polyester 2 and that Resin Dispersion 1 was added to Aqueous Phase 1.

### Comparative Example 6

A toner of Comparative Example 6 was produced in the same manner as in Example 1 except that Polyester 3 was used instead of Polyester 2 and that Resin Dispersion 12 was used instead of Resin Dispersion 1.

### Comparative Example 7

A toner of Comparative Example 7 was produced in the same manner as in Example 1 except that Polyester 3 was used instead of Polyester 2 and that Resin Dispersion 13 was used to instead of Resin Dispersion 1.

Specifications of Resin Dispersions 1 to 13 are shown in Table 1 below, and specifications of the toners of Examples 1 to 13 and Comparative Examples 1 to 7 are shown in Table 2 below.

TABLE 1

| | | Volume | | | |
|---|---|---|---|---|---|
| | | average | | | |
| | | particle | | | |
| | Volume | diameter/ | | | |
| | average | Number | Number | Weight | Glass |
| | particle | average | average | average | transition |
| Resin | diameter | particle | molecular | molecular | temperature |
| Dispersion | (nm) | diameter | weight | weight | (° C.) |
| Resin | 135 | 1.12 | 8,300 | 16,900 | 83 |
| Dispersion | | | | | |
| 1 | | | | | |
| Resin | 135 | 1.14 | 8,600 | 17,300 | 55 |
| Dispersion | | | | | |
| 2 | | | | | |
| Resin | 100 | 1.18 | 60,000 | 215,500 | 99 |
| Dispersion | | | | | |
| 3 | | | | | |
| Resin | 115 | 1.16 | 98,400 | 421,900 | 70 |
| Dispersion | | | | | |
| 4 | | | | | |
| Resin | 100 | 1.17 | 60,000 | 215,500 | 99 |
| Dispersion | | | | | |
| 5 | | | | | |
| Resin | 113 | 1.17 | 68,700 | 317,600 | 75 |
| Dispersion | | | | | |
| 6 | | | | | |
| Resin | 79 | 1.24 | 33,900 | 160,800 | 87 |
| Dispersion | | | | | |
| 7 | | | | | |
| Resin | 100 | 1.17 | 31,300 | 88,300 | 75 |
| Dispersion | | | | | |
| 8 | | | | | |
| Resin | 103 | 1.14 | 2,700 | 6,100 | 44 |
| Dispersion | | | | | |
| 9 | | | | | |
| Resin | 100 | 1.24 | 61,700 | 215,200 | 101 |
| Dispersion | | | | | |
| 10 | | | | | |
| Resin | 112 | 1.29 | 6,800 | 14,700 | 66 |
| Dispersion | | | | | |
| 11 | | | | | |
| Resin | 115 | 1.15 | 87,600 | 391,700 | 48 |
| Dispersion | | | | | |
| 12 | | | | | |
| Resin | 122 | 1.17 | 61,900 | 183,500 | 99 |
| Dispersion | | | | | |
| 13 | | | | | |

TABLE 2

| | | | | | Toner particle | | | Length of long | | |
|---|---|---|---|---|---|---|---|---|---|---|
| | Colored particle | | Protruding | | Volume | | Glass | side of protruding | | |
| | Polyester | | portion | | average | | transition | portion | | Coverage |
| | (Non-crystalline | Crystalline | Resin | Amount | particle | | temperature | Average | Standard | Average |
| | polyester) | polyester | dispersion | (part) | diameter (μm) | Circularity | (° C.) | (μm) | deviation | (%) |
| Ex. 1 | 2 | Not used | 1 | 5 | 6.5 | 0.985 | 65.4 | 0.23 | 0.100 | 56 |
| Ex. 2 | 3 | Not used | 1 | 5 | 6.3 | 0.986 | 54.6 | 0.21 | 0.099 | 61 |
| Ex. 3 | 3 | Not used | 2 | 5 | 6.6 | 0.985 | 54.6 | 0.26 | 0.105 | 51 |
| Ex. 4 | 3 | Not used | 3 | 5 | 6.8 | 0.986 | 56.3 | 0.27 | 0.115 | 54 |
| Ex. 5 | 3 | Not used | 4 | 5 | 6.7 | 0.980 | 54.5 | 0.39 | 0.103 | 53 |
| Ex. 6 | 3 | Not used | 5 | 5 | 7.6 | 0.980 | 55.5 | 0.22 | 0.090 | 49 |
| Ex. 7 | 3 | Not used | 6 | 5 | 8.6 | 0.976 | 54.7 | 0.29 | 0.116 | 52 |
| Ex. 8 | 3 | Not used | 7 | 5 | 6.7 | 0.980 | 54.7 | 0.25 | 0.103 | 32 |
| Ex. 9 | 3 | Not used | 8 | 5 | 6.6 | 0.985 | 54.5 | 0.23 | 0.086 | 81 |
| Ex. 10 | 3 | Not used | 1 | 5 | 8.1 | 0.986 | 54.4 | 0.34 | 0.119 | 36 |
| Ex. 11 | 1 | Not used | 1 | 5 | 5.5 | 0.985 | 49.2 | 0.30 | 0.112 | 49 |
| Ex. 12 | 3 | Not used | 9 | 5 | 6.7 | 0.982 | 55.0 | 0.22 | 0.100 | 62 |
| Ex. 13 | 3 | Not used | 10 | 5 | 6.5 | 0.981 | 54.7 | 0.21 | 0.103 | 59 |
| Comp. | 2 | Not used | — | — | 5.7 | 0.986 | 65.9 | — | — | — |
| Ex. 1 | | | | | | | | | | |
| Comp. | 3 | Not used | 11 | 20 | 8.1 | 0.980 | 57.5 | — | — | — |
| Ex. 2 | | | | | | | | | | |
| Comp. | 3 | Not used | 1 | 25 | 4.9 | 0.931 | 55.1 | 0.40 | 0.216 | 98 |
| Ex. 3 | | | | | | | | | | |
| Comp. | 3 | Not used | 1 | 5 | 5.5 | 0.982 | 54.5 | 0.19 | 0.056 | 54 |
| Ex. 4 | | | | | | | | | | |
| Comp. | 3 | Not used | 1 | 5 | 6.7 | 0.978 | 54.6 | 0.72 | 0.492 | 58 |
| Ex. 5 | | | | | | | | | | |
| Comp. | 3 | Not used | 12 | 5 | 6.7 | 0.986 | 54.7 | 0.52 | 0.223 | 67 |
| Ex. 6 | | | | | | | | | | |
| Comp. | 3 | Not used | 13 | 5 | 6.9 | 0.987 | 55.5 | 0.23 | 0.106 | 28 |
| Ex. 7 | | | | | | | | | | |

Properties of each of the toners produced were evaluated as described below. The results are shown in Table 3 below.

### <Background Smear>

White solid images were output to 2,000 sheets using a color electrophotographic type image forming apparatus (IPSIO SP C220, manufactured by Ricoh Company, Ltd.). Thereafter, toner attached onto a photoconductor during the printing of the white solid images was removed from the photoconductor with Scotch tape and subsequently affixed to white paper, then ΔE was measured using a spectroscopic densitometer and evaluated in four grades in accordance with the following evaluation criteria.

### [Evaluation Criteria]

A: ΔE=less than 3

B: ΔE=3 or greater, but less than 5

C: ΔE=5 or greater, but less than 10

D: ΔE=10 or greater

### <Adhesion Resistance>

White solid images were output to 2,000 sheets using a color electrophotographic type image forming apparatus (IPSIO SP C220, manufactured by Ricoh Company, Ltd.). Thereafter, toner attached to a regulatory blade was evaluated in four grades in accordance with the following evaluation criteria.

### [Evaluation Criteria]

A: There was no attachment of toner, excellent adhesion resistance confirmed.

B: Attachment of toner was not noticeable and there was no adverse effect on image quality.

C: Attachment of toner was confirmed and there was an adverse effect on image quality.

D: Attachment of toner was noticeable and there was a great adverse effect on image quality.

### <Transfer Rate>

A color electrophotographic type image forming apparatus (IPSIO SP C220, manufactured by Ricoh Company, Ltd.) was used, and the amount of toner in a black solid image (7.8 cm×1.0 cm) on a photoconductor and the amount of toner in a black solid image (7.8 cm×1.0 cm) on a transfer belt were measured. Based upon the amounts obtained, the transfer rate was calculated using the equation below and evaluated in four grades in accordance with the following evaluation criteria.

Transfer rate=(Amount of toner on transfer belt/Amount of toner on photoconductor)×100

### [Evaluation Criteria]

A: 90% or more

B: 80% or more, but less than 90%

C: 70% or more, but less than 80%

D: Less than 70%

### <Transfer Unevenness>

A color electrophotographic type image forming apparatus (IPSIO SP C220, manufactured by Ricoh Company, Ltd.) was used, and transfer unevenness regarding a black solid image (7.8 cm×1.0 cm) on a transfer belt was visually observed and evaluated in four grades in accordance with the following evaluation criteria.

### [Evaluation Criteria]

A: There was no transfer unevenness, excellent prevention of transfer unevenness confirmed.

B: There was transfer unevenness but there was no adverse effect on image quality.

C: There was transfer unevenness and there was an adverse effect on image quality.

D: There was noticeable transfer unevenness and there was a great adverse effect on image quality.

### <Cleanability>

White solid images were output to 2,000 sheets using a color electrophotographic type image forming apparatus (IPSIO SP C220, manufactured by Ricoh Company, Ltd.). Thereafter, a white solid image was output, and the existence or absence of cleaning failure was evaluated in four grades in accordance with the following evaluation criteria.

### [Evaluation Criteria]

A: There was no cleaning failure, excellent cleanability confirmed.

B: There was cleaning failure but it was not problematic in practical use.

C: There was cleaning failure and it was problematic in practical use.

D: There was noticeable cleaning failure.

### <Fixation Lower-Limit Temperature>

Black solid unfixed images (in an amount of 1.0 mg/cm² each) were formed on sheets of plain paper using a fixing unit of a color electrophotographic type image forming apparatus (IPSIO SP C220, manufactured by Ricoh Company, Ltd.). The sheets were fed, with changes in heating temperature. The lower-limit temperature which does not cause image quality-related problems was defined as the fixation lower-limit temperature, and the fixation lower-limit temperature was evaluated in accordance with the following evaluation criteria.

### [Evaluation Criteria]

A: Lower than 140° C.

B: 140° C. or higher, but lower than 150° C.

C: 150° C. or higher, but lower than 160° C.

D: 160° C. or higher

### <Hot Offset>

Black solid unfixed images (in an amount of 1.0 mg/cm² each) were formed on sheets of plain paper using a fixing unit of a color electrophotographic type image forming apparatus (IPSIO SP C220, manufactured by Ricoh Company, Ltd.). The black solid unfixed images were fixed to the sheets with changes in fixation temperature. The temperature at which hot offset arose was measured and evaluated in four grades in accordance with the following evaluation criteria.

### [Evaluation Criteria]

A: 190° C. or higher

B: 180° C. or higher, but lower than 190° C.

C: 170° C. or higher, but lower than 180° C.

D: Lower than 170° C.

### <Deformation of Toner>

One milligram of a toner sample was placed between two glass slides (S-1111, manufactured by MATSUNAMI GLASS IND., LTD.), then a load of 1 kg was applied over the toner sample placed between the two glass slides, and the toner sample in this state was left to stand for 3 days at 40° C. and a relative humidity of 90%. Thereafter, based upon an SEM image of the toner released, the extent of deformation of the toner was evaluated in accordance with the following evaluation criteria.

### [Evaluation Criteria]

A: There was no deformation of the toner confirmed.

B: The toner slightly deformed at the contact surface between the toner and the glass.

C: The toner deformed, with its surface being flat and smooth, but there were empty spaces also seen.

D: The toner deformed and fused, and there were no empty spaces seen.

### <Accelerated Cohesion>

The accelerated cohesion of the toner was measured using the Powder Tester PT-R (manufactured by Hosokawa Micron Corporation). Sieves having mesh sizes of 20 μm, 45 μm and 75 μm respectively were used for the measurement. The accelerated cohesion of a toner sample which had been left to stand for 24 hours at 25° C. and a relative humidity of 50% and the accelerated cohesion of a toner sample which had been left to stand for 24 hours at 40° C. and a relative humidity of 0.90% were measured, and the difference between the obtained values was evaluated in accordance with the following evaluation criteria.

### [Evaluation Criteria]

A: The difference was smaller than 2.5%.

B: The difference was 2.5% or greater, but smaller than 5.0%.

C: The difference was 5.0% or greater, but smaller than 7.5%.

D: The difference was 7.5% or greater.

### <Penetration>

Ten grams of a toner (sample) was placed in a 30 mL screw bottle, then set in a constant-temperature bath (DK340S), and left to stand for 24 hours at 40° C. and a relative humidity of 90%. Thereafter, the sample was released and cooled in air at room temperature. The penetration of the sample was measured using a penetration tester and evaluated in four grades in accordance with the following evaluation criteria.

### [Evaluation Criteria]

A: 15.0 mm or greater

B: 10.0 mm or greater, but less than 15.0 mm

C: 5.0 mm or greater, but less than 10.0 mm

D: Less than 5.0 mm

TABLE 3

| | Development | | Transfer | | | Fixation | | Heat-resistant storage stability | | |
|---|---|---|---|---|---|---|---|---|---|---|
| | Background | Adhesion | Transfer | Transfer | | Lower-limit | Hot | | Accelerated | |
| | smear | resistance | rate | unevenness | Cleanability | temperature | offset | Deformation | cohesion | Penetration |
| Ex. 1 | A | A | A | A | A | B | A | A | A | A |
| Ex. 2 | A | A | A | A | A | A | A | B | B | B |
| Ex. 3 | B | A | A | A | A | A | A | B | B | B |
| Ex. 4 | B | A | A | A | A | A | A | B | B | B |
| Ex. 5 | A | B | A | A | A | A | A | B | B | B |
| Ex. 6 | B | B | A | A | B | A | A | B | B | B |
| Ex. 7 | B | A | A | A | A | A | A | B | B | B |
| Ex. 8 | B | A | A | A | A | A | A | B | B | B |
| Ex. 9 | B | A | A | A | A | A | A | B | B | B |
| Ex. 10 | B | A | A | A | A | A | A | B | B | B |
| Ex. 11 | B | B | A | A | A | A | A | C | C | C |
| Ex. 12 | B | D | B | B | A | A | A | B | C | C |
| Ex. 13 | A | A | A | A | A | C | A | B | B | B |
| Comp | D | C | C | C | D | B | A | A | D | C |
| Ex. 1 | | | | | | | | | | |
| Comp | D | C | B | D | D | A | A | B | D | D |
| Ex. 2 | | | | | | | | | | |
| Comp | D | D | D | D | D | D | A | B | C | B |
| Ex. 3 | | | | | | | | | | |
| Comp | D | D | D | D | D | A | A | B | D | D |
| Ex. 4 | | | | | | | | | | |
| Comp | D | C | D | D | B | A | A | B | D | D |
| Ex. 5 | | | | | | | | | | |
| Comp | C | D | C | C | A | C | A | B | D | C |
| Ex. 6 | | | | | | | | | | |
| Comp | D | B | C | C | D | A | A | B | D | D |
| Ex. 7 | | | | | | | | | | |

### <Synthesis of Crystalline Polyester>

### (Crystalline Polyester 1)

In a reaction container equipped with a condenser tube, a stirrer and a nitrogen-introducing tube, 500 parts of 1,6-hexanediol, 500 parts of succinic acid and 2.5 parts of dibutyltin oxide were placed. Subsequently, the ingredients were reacted together for 8 hours at normal pressure and at 200° C., then further reacted together for 1 hour at a reduced pressure of 10 mmHg to 15 mmHg, and Crystalline Polyester 1 was thus obtained. Crystalline Polyester 1 exhibited an endothermic peak at 65° C. in a DSC measurement.

### (Crystalline Polyester 2)

In a reaction container equipped with a condenser tube, a stirrer and a nitrogen-introducing tube, 500 parts of 1,6-hexanediol, 590 parts of fumaric acid, 90 parts of terephthalic acid and 2.5 parts of dibutyltin oxide were placed. Subsequently, the ingredients were reacted together for 8 hours at normal pressure and at 200° C., then further reacted together for 1 hour at a reduced pressure of 10 mmHg to 15 mmHg, and Crystalline Polyester 2 was thus obtained. Crystalline Polyester 2 exhibited an endothermic peak at 110° C. in a DSC measurement.

### Example 14

### Production of Oil Phase

In a container equipped with a stirring rod and a thermometer, 4 parts of Polyester 2, 20 parts of Crystalline Polyester 1, 8 parts of a paraffin wax (melting point: 72° C.) and 96 parts of ethyl acetate were placed. While the ingredients were being stirred, the temperature was increased to 80° C. Then the temperature was kept at 80° C. for 5 hours, and subsequently cooling was carried out such that the temperature decreased to 30° C. in 1 hour. Subsequently, 35 parts of Master Batch 1 was added, which was followed by mixing for 1 hour. Thereafter, the ingredients were placed in another container, then subjected to dispersion treatment using a bead mill (ULTRA VISCO MILL, manufactured by AIMEX CO., Ltd.) under the following conditions: the liquid sending rate was 1 kg/hr, the disc circumferential velocity was 6 m/sec, zirconia beads of 0.5 mm each were supplied so as to occupy 80% by volume, and the ingredients were passed three times. In this manner, Raw Material Solution 1 was obtained. Subsequently, 74.1 parts of a 70% ethyl acetate solution of Polyester 2, 21.6 parts of Crystalline Polyester 1 and 21.5 parts of ethyl acetate were added to 81.3 parts of Raw Material Solution 1, then the ingredients were stirred for 2 hours using a three-one motor, and Oil Phase 1 was thus obtained. Ethyl acetate was added to Oil Phase 1 such that Oil Phase 1 had a solid content concentration (measured at 130° C. for 30 minutes) of 49%.

### <Preparation of Aqueous Phase>

A milky-white liquid was obtained by mixing and stirring 472 parts of ion-exchange water, 81 parts of a 50% aqueous solution of sodium dodecyl diphenyl ether disulfonate (ELEMINOL MON-7, manufactured by Sanyo Chemical Industries, Ltd.), 67 parts of a 1% aqueous solution of carboxymethyl cellulose as a thickener, and 54 parts of ethyl acetate. The obtained liquid was named “Aqueous Phase 1”.

### <Emulsifying Step>

The whole amount of Oil Phase 1 was subjected to mixing for 1 minute using T.K. HOMO MIXER (manufactured by Tokushu Kika Kogyo Co., Ltd.) at a rotational speed of 5,000 rpm. Thereafter, 321 parts of Aqueous Phase 1 was added, which was followed by mixing for 20 minutes using T.K. HOMO MIXER with its rotational speed adjusted to the range of 8,000 rpm to 13,000 rpm, and Core Particle Slurry 1 was thus obtained.

### <Shell-Attaching Step (Step of Attaching Resin Fine Particles to Core Particles)>

While Core Particle Slurry 1 was being stirred using a three-one motor at a rotational speed of 200 rpm, 21.4 parts of Resin Dispersion 1 was dripped in 5 minutes, then the stirring was continued for 30 minutes. Thereafter, when a small amount of a slurry sample was collected, diluted with water which was 10 times larger in amount, and then centrifuged using a centrifuge, it was confirmed that toner base particles had precipitated at the bottom of a test tube and the supernatant liquid was almost transparent. In this manner, Shell-attached Slurry 1 was obtained.

### <Solvent Removal>

In a container equipped with a stirrer and a thermometer, Shell-attached Slurry 1 was placed, then the solvent was removed at 30° C. in 8 hours, and Dispersion Slurry 1 was thus obtained.

### <Washing and Drying>

After 100 parts of Dispersion Slurry 1 was filtered under reduced pressure, the following operations were carried out.

(1) To the filter cake, 100 parts of ion-exchange water was added, then mixing was carried out using T.K. HOMO. MIXER (rotational speed: 12,000 rpm, length of time: 10 minutes), and subsequently filtration was carried out under reduced pressure.
(2) To the filter cake obtained by (1), 100 parts of ion-exchange water was added, then mixing was carried out using T.K. HOMO MIXER (rotational speed: 12,000 rpm, length of time: 30 minutes) with the provision of ultrasonic vibration, and subsequently filtration was carried out under reduced pressure. This process was repeated such that the electrical conductivity of the reslurry liquid became 10 μS/cm or less.
(3) In order that the pH of the reslurry liquid obtained by (2) should stand at 4, 10% hydrochloric acid was added, then mixing was carried out for 30 minutes using a three-one motor, and subsequently filtration was carried out.
(4) To the filter cake obtained by (3), 100 parts of ion-exchange water was added, then mixing was carried out using T.K. HOMO MIXER (rotational speed: 12,000 rpm, length of time: 10 minutes), and subsequently filtration was carried out. This process was repeated such that the electrical conductivity of the reslurry liquid became 10 μS/cm or less, and Filter Cake 1 was thus obtained. The rest of Dispersion Slurry 1 was similarly washed and additionally mixed as Filter Cake 1.

Filter Cake 1 was dried at 45° C. for 48 hours using a wind circulation dryer, and then sieved using a mesh with a sieve mesh size of 75 μm, and Toner Base 1 was thus obtained. One part of hydrophobic silica (whose primary particle diameter was approximately 30 nm) and 0.5 parts of hydrophobic silica (whose primary particle diameter was approximately 10 nm) were mixed with 50 parts of Toner Base 1 using a Henschel mixer, and a toner of Example 14 was thus obtained.

FIG. 9 is an SEM photograph showing a particle of Toner Base 1 obtained. The toner surface has a sea-island structure in which island portions protrude from a sea portion and are present as convex portions. These island portions are made of resin fine particles.

### Example 15

A toner of Example 15 was produced in the same manner as in Example 14, except that Crystalline Polyester 2 was used instead of Crystalline Polyester 1.

### Example 16

A toner of Example 16 was produced in the same manner as in Example 14, except that Resin Dispersion 6 was used instead of Resin Dispersion 1 in the shell-attaching step.

### Example 17

In a container equipped with a stirring rod and a thermometer, 4 parts of Polyester 3, 20 parts of Crystalline Polyester 1, 8 parts of a paraffin wax (melting point: 72° C.) and 96 parts of ethyl acetate were placed. While the ingredients were being stirred, the temperature was increased to 80° C. The temperature was kept at 80° C. for 5 hours, and then cooling was carried out such that the temperature decreased to 30° C. in 1 hour. Subsequently, 35 parts of Master Batch 1 was, added, which was followed by mixing for 1 hour. Thereafter, the ingredients were placed in another container and then subjected to dispersion treatment using a bead mill (ULTRA VISCO MILL, manufactured by AIMEX CO., Ltd.) under the following conditions: the liquid sending rate was 1 kg/hr, the disc circumferential velocity was 6 m/sec, zirconia beads of 0.5 mm each were supplied so as to occupy 80% by volume, and the ingredients were passed three times. In this manner, Raw Material Solution 1 was obtained. Subsequently, 84.4 parts of a 70% ethyl acetate solution of Polyester 3 was added to 81.3 parts of Raw Material Solution 1, which was followed by stirring for 2 hours using a one-three motor, and Oil Phase 4 was thus obtained. Ethyl acetate was added to Oil Phase 4 such that Oil Phase 4 had a solid content concentration (measured at 130° C. for 30 minutes) of 50%.

### <Emulsifying Step>

To the whole amount of Oil Phase 4, 0.4 parts of isophoronediamine and 28.5 parts of Isocyanate-modified Polyester 1 were added, which was followed by mixing for 1 minute using T.K. HOMO MIXER (manufactured by Tokushu Kika Kogyo Co., Ltd.) at a rotational speed of 5,000 rpm. Thereafter, the whole amount of Aqueous Phase 1 was added, which was followed by mixing for 20 minutes using T.K. HOMO MIXER with its rotational speed adjusted to the range of 8,000 rpm to 13,000 rpm, and Core Particle Slurry 4 was thus obtained.

### <Shell-Attaching Step>

While Core Particle Slurry 4 was being stirred using a three-one motor at a rotational speed of 200 rpm, 21.4 parts of Resin Dispersion 1 was dripped in 5 minutes, then the stirring was continued for 30 minutes. Thereafter, when a small amount of a slurry sample was collected, diluted with water which was 10 times larger in amount, and then centrifuged using a centrifuge, it was confirmed that toner base particles had precipitated at the bottom of a test tube and the supernatant liquid was almost transparent. In this manner, Shell-attached Slurry 4 was obtained.

Subsequent steps were carried out in the same manner as in Example 14, and a toner of Example 17 was thus produced.

Properties of each of the toners of Examples 14 to 17 were evaluated as in the cases of the toners of Examples 1 to 13 and Comparative Examples 1 to 7. Specifications of the toners of Examples 14 to 17 are shown in Table 4 below, and the results of the evaluations are shown in Table 5 below.

TABLE 4

| | | | | | | | | Length of | | |
|---|---|---|---|---|---|---|---|---|---|---|
| | Colored particle | | Protruding | | Toner particle | | | long side of | | |
| | Polyester | | portion | | Volume average | | Glass transition | protruding portion | | Coverage |
| | (Non-crystalline | Crystalline | Resin | Amount | particle diameter | | temperature | | Standard | Average |
| | polyester) | polyester | dispersion | (part) | (μm) | Circularity | (° C.) | Average (μm) | deviation | (%) |
| Ex. 14 | 2 | 1 | 1 | 5 | 6.5 | 0.978 | 39.0 | 0.25 | 0.122 | 39 |
| Ex. 15 | 2 | 2 | 1 | 5 | 6.3 | 0.972 | 41.5 | 0.30 | 0.114 | 43 |
| Ex. 16 | 2 | 1 | 6 | 5 | 6.2 | 0.975 | 40.2 | 0.29 | 0.109 | 35 |
| Ex. 17 | 3 | 1 | 1 | 5 | 6.8 | 0.975 | 40.1 | 0.34 | 0.117 | 48 |

TABLE 5

| | Development | | Transfer | | | Fixation | | Heat-resistant storage stability | | |
|---|---|---|---|---|---|---|---|---|---|---|
| | Background | Adhesion | Transfer | Transfer | | Lower-limit | Hot | | Accelerated | |
| | smear | resistance | rate | unevenness | Cleanability | temperature | offset | Deformation | cohesion | Penetration |
| Ex. 14 | A | A | B | B | A | A | A | A | B | B |
| Ex. 15 | B | B | B | B | A | A | A | B | B | B |
| Ex. 16 | B | B | B | B | A | A | A | A | B | B |
| Ex. 17 | A | A | B | B | A | A | A | B | B | B |

### REFERENCE SIGNS LIST

1Y, 1C, 1M and 1K photoconductor
2Y, 2C, 2M and 2K image forming portion
3 charging device
3K latent electrostatic image bearing member
4 exposing device
5 developing device
5a developing roller
5b developer supplying roller
5c regulatory blade
6 transfer device
7 cleaning device
7K charging unit
8K elastic portion
9K conductive sheet
10K charging member
10 intermediate transfer belt
11, 12, 13 supporting roller
14 primary transfer roller
15 belt cleaning device
16 secondary transfer roller
20 paper feed cassette
21 paper feed roller
22 pair of registration rollers
23 heat fixing device
23a heating roller
23b pressurizing roller
24 paper discharge roller
31Y, 31C, 31M, 31K toner bottle
40K developing unit
41K casing
42K developing roller
43K agitator
44K toner supplying roller
45K regulatory blade
49A developer storing container
50A process cartridge
61 transfer target material
66K transfer unit

1. A toner, comprising:
a binder resin;
a colorant; and
protruding portions on a surface of the toner,
wherein:
an average length of long sides of the protruding portions is 0.1 μm or greater, but less than 0.5 μm;
a standard deviation of lengths of the long sides of the protruding portions is 0.2 or less; and
the protruding portions have a coverage of 30% to 90%.

2. The toner according to claim 1, wherein the toner has a glass transition temperature Tg1 satisfying (1):
45° C.≦Tg1≦70° C. (1).

3. The toner according to claim 1, wherein the protruding portions comprise a resin having a glass transition temperature Tg2 satisfying (2):
45° C.≦Tg2≦100° C. (2).

4. The toner according to claim 1, wherein the glass transition temperature Tg1 of the toner and the glass transition temperature Tg2 of the resin satisfy (3) to (5):
50° C.≦Tg1≦65° C. (3);
60° C.≦Tg2≦100° C. (4); and
Tg1<Tg2 (5).

5. The toner according to claim 3, wherein the resin is a styrene-containing resin.

6. The toner according to claim 3, wherein a mass of the resin is 1% to 20% of a total mass of the toner.

7. The toner according to claim 3, wherein the resin is a vinyl resin obtained by polymerizing a monomer mixture comprising 80% by mass to 100% by mass of an aromatic compound having a vinyl polymerizable functional group, relative to a total mass of the monomer mixture.

8. The toner according to claim 3, wherein the resin is a vinyl resin obtained by polymerizing a monomer mixture comprising 100% by mass of an aromatic compound having the vinyl polymerizable functional group relative to a total mass of the monomer mixture.

9. The toner according to claim 7, wherein the monomer mixture comprises 80% by mass to 100% by mass of styrene and 0% by mass to 20% by mass of butyl acrylate, such that a total amount of these two components ranges from 90% by mass to 100% by mass relative to the total mass of the monomer mixture.

10. The toner according to claim 1, wherein the toner has a volume average particle diameter of 3 μm to 9 μm.

11. The toner according to claim 1, wherein a ratio of the volume average particle diameter of the toner to a number average particle diameter of the toner is 1.25 or less.

12. The toner according to claim 1, wherein the toner has an average circularity of 0.93 or greater.

13. An image forming apparatus comprising:
a latent image bearing member configured to bear a latent image thereon;
a charging unit configured to uniformly charge a surface of the latent image bearing member;
an exposing unit configured to expose the charged surface of the latent image bearing member, based upon image data, so as to write a latent electrostatic image on the surface of the latent image bearing member;
a developing unit configured to supply a toner to the latent electrostatic image formed on the surface of the latent image bearing member so as to develop the latent electrostatic image and thereby form a visible image;
a transfer unit configured to transfer the visible image on the surface of the latent image bearing member to a transfer target object; and
a fixing unit configured to fix the visible image on the transfer target object,
wherein:
the toner comprises:
a binder resin;
a colorant; and
protruding portions on a surface of the toner;
an average length of long sides of the protruding portions is 0.1 μm or greater, but less than 0.5 μm;
a standard deviation of lengths of the long sides of the protruding portions is 0.2 or less; and
the protruding portions have a coverage of 30% to 90%.

14. (canceled)

15. A process cartridge detachably mountable to an image forming apparatus, comprising:
a latent image bearing member; and
a developing unit configured to develop a latent electrostatic image on the latent image bearing member with a toner,
wherein:
the latent image bearing member and the developing unit constitute a single unit;
the toner comprises:
a binder resin;
a colorant; and
protruding portions on a surface of the toner;
an average length of long sides of the protruding portions is 0.1 μm or greater, but less than 0.5 μm;
a standard deviation of lengths of the long sides of the protruding portions is 0.2 or less; and
the protruding portions have a coverage of 30% to 90%.

16. The toner according to claim 2, wherein the protruding portions comprise a resin having a glass transition temperature Tg2 satisfying (2):
45° C.≦Tg2≦100° C. (2).

17. The toner according to claim 4, wherein the resin is a styrene-containing resin.

18. The toner according to claim 2, wherein the toner has a volume average particle diameter of 3 μm to 9 μm.

19. The toner according to claim 3, wherein the toner has a volume average particle diameter of 3 μm to 9 μm.

20. The toner according to claim 4, wherein the toner has a volume average particle diameter of 3 μm to 9 μm.
